(19) United States
(12) Patent Application Publication
(10) Pub. No.: US 2026/0017623 A1
(43) Pub. Date: Jan. 15, 2026

(54) INFORMATION PROCESSING METHOD, DISPLAY METHOD, INFORMATION PROCESSING DEVICE, AND NON-TRANSITORY COMPUTER READABLE STORAGE MEDIUM

(71) Applicant: PANASONIC INTELLECTUAL PROPERTY MANAGEMENT CO., LTD., Osaka (JP)

(72) Inventor: Masahiro TAGUCHI, Osaka (JP)

(21) Appl. No.: 19/334,165

(22) Filed: Sep. 19, 2025

Related U.S. Application Data
(63) Continuation of application No. PCT/JP2024/011371, filed on Mar. 22, 2024.

(30) Foreign Application Priority Data
Mar. 24, 2023 (JP) 2023-048649

(51) Int. Cl. G06Q 10/30; G06Q 30/0208

(52) U.S. Cl. CPC G06Q 10/30; G06Q 30/0208

(57) ABSTRACT

A server 2 acquires collection state information on a battery 11 that is collected by a collection base 30 and acquires collection target information on a target battery to be collected. When it is determined that the target battery is not collectable from the collection base 30 based on the collection state information and the collection target information, the server acquires user battery information on a battery 11 owned by each of one or more users, and outputs recommendation information for recommending replacement of the target battery at the collection base 30 to a user terminal 6 that is used by each of one or more target users, the target users being identified based on the user battery information.

### FIELD OF INVENTION

The present disclosure relates to a technique for collecting a battery.

### BACKGROUND ART

Patent Literature 1 discloses a technique for collecting a battery to be collected at a replacement station using information acquired from an electric vehicle equipped with a battery that satisfies predetermined collection conditions such as a service life and a travel distance.

However, in Patent Literature 1, it is not considered to collect a battery to be collected in consideration of information on the battery collected by the replacement station.
Patent Literature 1: JP 2010-212048 A

### SUMMARY OF THE INVENTION

The present disclosure has been made to solve such a problem, and it is an object of the present disclosure to provide a technique capable of efficiently collecting a battery to be collected in consideration of not only a battery owned by a user but also information on a battery collected by a base.

An information processing method according to one aspect of the present disclosure causes a computer to execute: acquiring first information on a battery collected by a base; acquiring second information on a target battery to be collected; determining whether the target battery is collectable from the base based on the first information and the second information; when it is determined that the target battery is not collectable from the base, acquiring third information on a battery owned by each of one or more users; specifying one or more target users who own the target battery based on the third information; and outputting fourth information recommending replacement of the target battery at the base to a terminal device used by each of the one or more target users.

### BRIEF DESCRIPTION OF THE DRAWINGS

FIG. 1 is a diagram illustrating a use case of replacing a current battery.

FIG. 2 is a diagram illustrating a use case of collecting a battery in the present disclosure.

FIG. 3 is a diagram illustrating an overall configuration of an information processing system according to an embodiment of the present disclosure.

FIG. 4 is a diagram illustrating one example of a configuration of a server.

FIG. 5 is a sequence diagram illustrating an example of processing performed in the information processing system.

FIG. 6 is a flowchart presenting an example of processing by the server.

FIG. 7 is a flowchart presenting an example of processing by the server.

FIG. 8 is a sequence diagram illustrating an example of processing of outputting recommendation information including a first reward.

FIG. 9 is a diagram illustrating an example of a map image including a first reward.

FIG. 10 is a sequence diagram illustrating an example of processing when the recommendation information including a second reward is output.

FIG. 11 is a diagram illustrating an example of a map image including a second reward.

FIG. 12 is a sequence diagram illustrating an example of processing when the recommendation information including a third reward is output.

FIG. 13 is a diagram illustrating an example of a map image including a third reward.

FIG. 14 is a diagram illustrating a display example of a map image having today as a collection date on a user terminal.

FIG. 15 is a diagram illustrating a display example of a map image having tomorrow as a collection date on a user terminal.

FIG. 16 is a diagram illustrating a display example of a predetermined map image on a user terminal.

### DETAILED DESCRIPTION

### Knowledge Underlying Present Disclosure

In recent years, techniques for efficiently collecting batteries have been studied for the purpose of mobility of electric motorcycles, electric bicycles, electric kickboards, and the like, reuse, recycling, failure inspection, and the like of batteries mounted on portable terminals such as notebook computers.

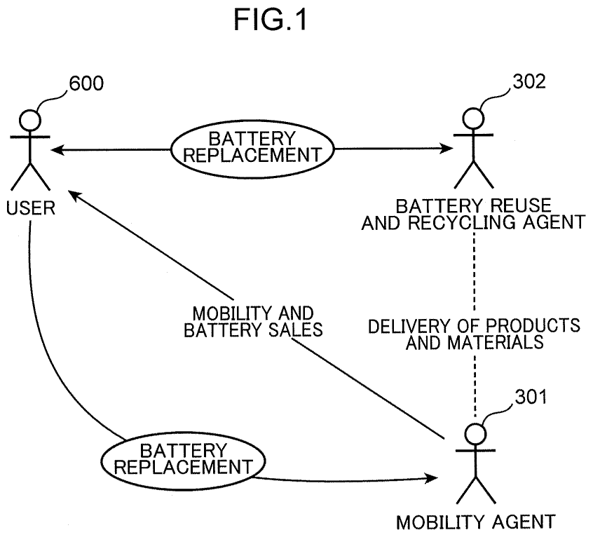

Current battery collection methods have the following problems. FIG. 1 is a diagram illustrating a use case of replacing a current battery. As illustrated in FIG. 1, currently, a battery reuse and recycling agent 302 directly replaces a battery with a user 600 by selling the battery to the user 600 and collecting the battery from the user 600. For this reason, the battery reuse and recycling agent 302 wants to handle many batteries, but there is a problem that the cost required to access the user 600 increases as the number of batteries to be handled increases.

Similarly to the battery reuse and recycling agent 302, a mobility agent 301 directly replaces the battery with the user 600. Specifically, the mobility agent 301 sells the mobility and spare batteries mounted with the batteries delivered from the battery reuse and recycling agent 302 to the user 600. In addition, the mobility agent 301 collects the battery from the user 600 for the purpose of failure inspection, repair, and the like, and provides the user 600 with a repaired battery or a substitute battery. For this reason, there is a problem that the cost required to access the user 600 increases as the number of mobility and spare batteries to be sold by the mobility agent 301 increases.

In order to solve the above problem, it is conceivable to cause the user 600 to bring or deliver the battery to the battery reuse and recycling agent 302 and the mobility agent 301. However, in this case, the user 600 may feel troublesome to move to bring the battery and arrange delivery of the battery.

The technique of Patent Literature 1 acquires information on a battery from a device that is being used by the user 600, and prompts the user 600 to replace the battery based on the information. In Patent Literature 1, it is not considered to collect a battery desired by a battery collection agent such as the battery reuse and recycling agent 302 and the mobility agent 301 in consideration of information on the battery collected by the replacement station.

Therefore, the present inventors have conducted intensive studies on a method by which battery collection agents such as the battery reuse and recycling agent 302 and the mobility agent 301 can efficiently collect desired batteries.

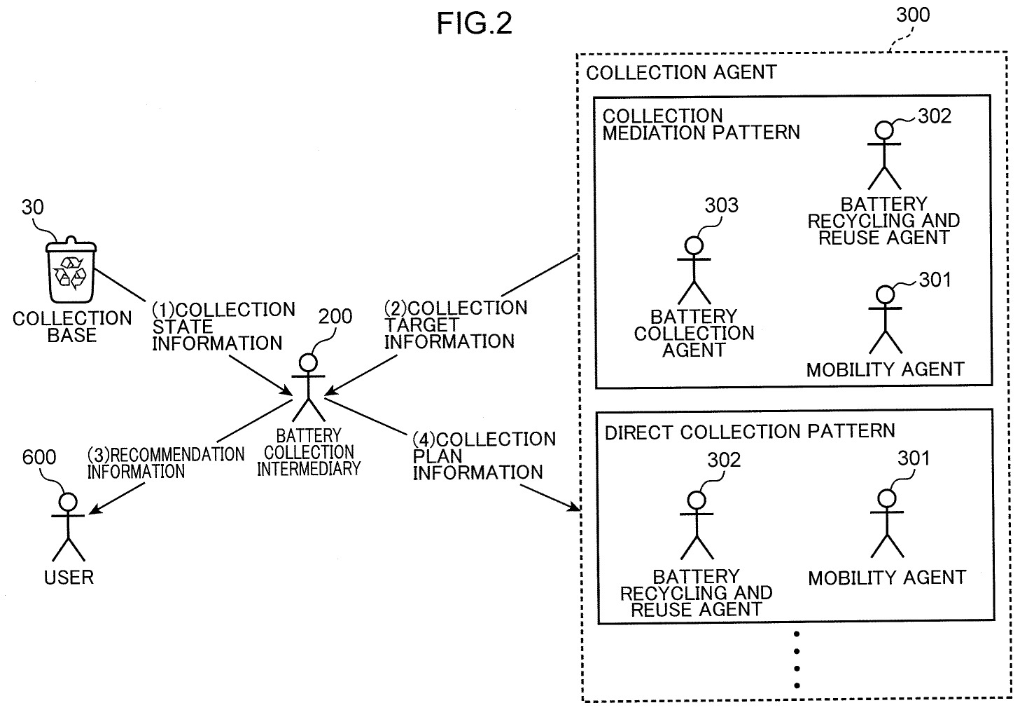

FIG. 2 is a diagram illustrating a use case of collecting a battery in the present disclosure. Specifically, as illustrated in FIG. 2, in the present use case, in addition to the user 600 who uses a battery, and a collection agent 300 such as the battery reuse and recycling agent 302 and the mobility agent 301, a battery collection intermediary 200 that mediates battery collection operation appears.

As a form of the collection agent 300, for example, a form including a battery collection agent 303 that actually collects a battery from a collection base 30 upon receiving a request from the battery reuse and recycling agent 302 and the mobility agent 301 (“collection mediation pattern”) is conceivable. In addition, for example, a form in which the battery reuse and recycling agent 302 and the mobility agent 301 actually perform an operation of collecting the battery from the collection base 30 (“direct collection pattern”) can be considered.

The battery collection intermediary 200 acquires information (hereinafter, collection state information) on batteries collected by the collection base (base) 30 where batteries can be replaced and collected, and acquires information (hereinafter, collection target information) on batteries (hereinafter, the target battery) to be collected from the collection agent 300.

The battery collection intermediary 200 prepares a plan for collecting the target battery from the collection base 30 based on the acquired collection state information and collection target information. When a plan in which the target battery is collectable from the collection base 30 can be prepared, the battery collection intermediary 200 provides the collection agent 300 with information (hereinafter, collection plan information) indicating the plan. As a result, the collection agent 300 can efficiently collect the target battery according to the collection plan information.

On the other hand, when the battery collection intermediary 200 cannot prepare a plan to collect the target battery from the collection base 30, the battery collection intermediary provides the user 600 who owns the target battery with information (hereinafter, recommendation information) that recommends replacing the target battery in the collection base 30. As a result, it is possible to improve the opportunity for the user 600 who has received the provision of the recommendation information to replace the target battery in the collection base 30. As a result, the cost required for the collection agent 300 to directly access the user 600 to collect the battery can be reduced.

As described above, the present disclosure is made in order to efficiently collect the battery to be collected in consideration of not only the battery owned by the user 600 but also the information on the battery collected by the collection base 30.
(1) An information processing method according to one aspect of the present disclosure causes a computer to execute: acquiring first information on a battery collected by a base; acquiring second information on a target battery to be collected; determining whether the target battery is collectable from the base based on the first information and the second information; when it is determined that the target battery is not collectable from the base, acquiring third information on a battery owned by each of one or more users; specifying one or more target users who own the target battery based on the third information; and outputting fourth information recommending replacement of the target battery at the base to a terminal device used by each of the one or more target users.

In this configuration, whether the target battery is collectable from the base is determined based on the first information on the battery collected by the base and the second information on the target battery to be collected. Therefore, in this configuration, it is possible to determine whether the target battery is collectable from the base in consideration of the battery collected by the base.

Further, in this configuration, when it is determined that the target battery is not collectable from the base, the fourth information for recommending replacement of the target battery at the base is output to the terminal device used by the target user who owns the target battery, the terminal device being specified based on the third information on the battery owned by each of the plurality of users.

Therefore, this configuration can improve the possibility that the user replaces the target battery at the base in consideration of not only the battery collected by the base but also the battery owned by the user. With this configuration, the possibility of collecting the target battery from the base can be improved, and the target battery can be efficiently collected.
(2) In the information processing method according to (1), the fourth information may include information indicating a reward given to each target user when the target battery is replaced at the base.

According to this configuration, it is possible to notify the target user who owns the target battery that a reward is given when the target battery is replaced at the base. This can further improve the possibility that the target user replaces the target battery at the base.
(3) In the information processing method according to (2), the reward may include a higher first reward as a matching degree between the second information and information on the target battery owned by each target user included in the third information is higher.

According to this configuration, it is possible to notify the target user whose information regarding the owned target battery is close to the second information that a high reward is given when the target battery is replaced at the base.
(4) In the information processing method according to (3), the second information may include a range of an SOH of the target battery, the third information may include an SOH of a battery owned by each user, and the matching degree may be higher as a target SOH, which is an SOH of the target battery owned by each target user, included in the third information falls within the range and is closer to an upper limit value of the range.

According to this configuration, it is possible to notify the target user whose SOH of the owned target battery falls within the range of the SOH of the target battery included in the second information and is close to the upper limit value of the range that a high reward is given when the target battery is replaced at the base.
(5) In the information processing method according to any one of (2) to (4), the base may include one or more collection bases, and the method may include: acquiring current locations of the one or more users and positions of the one or more collection bases; and outputting, as the fourth information, a map image on which a current location of each target user, positions of one or more display bases existing within a predetermined distance from the current location of each target user among the one or more collection bases, and information indicating whether each display base is a base where the reward is given to each target user by replacement of the target battery.

According to the present configuration, the map image on which the current location of the target user, the positions of one or more display bases existing within a predetermined distance from the current location of the target user, and information indicating whether each display base is a base where a reward is given to the target user by replacement of the target battery are displayed is output to the terminal device used by the target user.

Therefore, by referring to the map image, the target user can determine in which collection base existing within a predetermined distance the battery is replaced to obtain a reward.
(6) In the information processing method according to (2), the reward may include a second reward given to each target user when the target battery is replaced at the base through which the target battery is collected.

According to the present configuration, it is possible to notify the target user that the second reward is given in a case where the target battery is replaced at bases through which the target user passes to collect the target batteries of the total collection number.
(7) In the information processing method according to (6), the base includes one or more collection bases, the first information includes a number of batteries collected by each collection base, the second information includes a collection number that is the number of target batteries to be collected, and the method further comprises, when a total collection number, which is a total number of the target batteries collectable from the one or more collection bases, is less than the collection number, specifying one or more transit bases through which the target batteries of the total collection number are collected.

In this configuration, when the total collection number is less than the collection number, one or more transit bases through which the target batteries of the total collection number are collected are specified. Therefore, when the target batteries are collectable from one or more collection bases, it is possible to omit recalculation of one or more transit bases through which the target batteries of the total collection number are collected.
(8) The information processing method according to (7) may further include: acquiring current locations of the one or more users and positions of the one or more collection bases; and outputting, as the fourth information, a map image on which a current location of each target user, positions of one or more display bases existing within a predetermined distance from the current location of each target user among the one or more collection bases, a collection route to visit the one or more transit bases, and information indicating whether each display base is a base to which the second reward is given to each target user by replacement of the target battery are displayed.

According to the present configuration, the map image on which the current location of the target user, the positions of one or more display bases existing within a predetermined distance from the current location of the target user, a collection route to visit the one or more transit bases, and information indicating whether each display base is a base where the second reward is given to each target user by replacement of the target battery are displayed is output to the terminal device used by the target user.

Therefore, the target user can determine in which collection base on the collection route for collecting the battery the second reward can be obtained by replacing the battery by referring to the map image.
(9) In the information processing method according to (2), the base may include one or more collection bases, the first information may include a number of batteries collected by each collection base and the total number of batteries that are collectable by each collection base, the method may further include calculating, for each of the one or more collection bases, an operation rate that is a ratio of a number of batteries collected by each collection base to a total number of batteries collectable by each collection base based on the first information, and the reward may include a third reward given to each target user when the target battery is replaced in a collection base group in which the operation rate satisfying a predetermined condition is calculated among the one or more collection bases.

According to this configuration, it is possible to notify the target user that the third reward is given when the target battery is replaced in the collection base group in which the operation rate satisfying the predetermined condition is calculated.
(10) In the information processing method according to (9), the predetermined condition may be that the operation rate is lowest among the one or more collection bases.

According to this configuration, it is possible to notify the target user that the third reward is given when the target battery is replaced at the collection base in which the lowest operation rate among the one or more collection bases is calculated.
(11) In the information processing method according to (9), in the determining, when it is determined that the target battery is not collectable from the base, one or more transit bases may be further specified through which the target batteries of a total collection number are collected, the total collection number being a total number of the target batteries collectable from the one or more collection bases, and the predetermined condition may be that the operation rate is lowest among the one or more transit bases.

According to the present configuration, it is possible to notify the target user that the third reward is given when the target battery is replaced at the collection base in which the lowest operation rate among the one or more transit bases is calculated.
(12) The information processing method according to (9) may further include: when it is determined that the target battery is not collectable from the base, determining a route to visit one or more transit bases by specifying the one or more transit bases through which the target batteries of a total collection number are collected, the total collection number being a total number of the target batteries collectable from the one or more collection bases, in which the predetermined condition may be that the operation rate is lowest among a collection base group within a predetermined distance from the route among the one or more collection bases.

According to the present configuration, it is possible to notify the target user that the third reward is given when the target battery is replaced at the collection base in which the lowest operation rate among the collection base group within the predetermined distance from the route to visit the one or more transit bases is calculated.
(13) The information processing method according to any one of (9) to (12), may further include: acquiring current locations of the one or more users and positions of the one or more collection bases; and outputting, as the fourth information, a map image on which a current location of each target user, positions of one or more display bases existing within a predetermined distance from the current location of each target user among the one or more collection bases, the operation rate calculated for each of the one or more display bases, and information indicating whether each display base is a base to which the third reward is given to each target user by replacement of the target battery are displayed.

According to the present configuration, the map image on which the current location of the target user, the positions of one or more display bases existing within a predetermined distance from the current location of the target user, the operation rate calculated for each of the one or more display bases, and the information indicating whether each display base is a base to which the third reward is given to each target user by replacement of the target battery are displayed is output to the terminal device used by the target user.

Therefore, by referring to the map image, the target user can determine at the collection base having which degree of the operation rate the battery should be replaced to obtain the third reward.
(14) In the information processing method according to any one of (5), (8), and (13), the map image may further display a movement time from a current location of each target user to a display base closest to the current location of each target user among the one or more display bases.

According to the present configuration, the target user can further grasp how much movement time is required to obtain a reward with the least movement.
(15) In the information processing method according to any one of (1) to (14), the base may include one or more collection bases, the first information may include a number of batteries collected by each collection base and a total number of batteries that are collectable by each collection base, the second information may include a collection number that is a number of the target batteries to be collected, in the determining, the target battery may be determined to be collectable from the base when a total collection number, which is a total number of the target batteries collectable from the one or more collection bases, is equal to or larger than a number of the target batteries, when it is determined that the target battery is collectable from the base, one or more transit bases through which the target batteries of the collection number are collected may be specified, and further a route to visit the one or more transit bases may be determined, and information including the one or more transit bases and the route may be output to a terminal device used by a provider of the second information.

In this configuration, when it is determined that the target battery is collectable from the base, the map image including the one or more transit bases and the route is output to the terminal device used by the provider of the second information. Therefore, the provider of the second information can efficiently collect the target batteries of the collection number by referring to the map image and visiting the one or more transit bases through the route.
(16) In the information processing method according to any one of (1) to (15), the second information may further include a required time required for collecting the target battery.

According to this configuration, it is possible to determine whether the target battery is collectable from the base in consideration of not only the battery collected by the base but also the time required for collecting the target battery.
(17) A display method according to another aspect of the present disclosure is a display method in the terminal device according to any one of (5), (8), and (13) including: when a first map image on which a first collection date after a current date is displayed and a second map image on which a second collection date after the first collection date is displayed are received, displaying a screen on which an operation of displaying the first map image and the second map image is possible in a switched manner, in which the screen includes an icon indicating contents of the reward included in the first map image and the second map image.

According to this configuration, the target user can switch and display the first map image and the second map image while confirming the contents of the reward by operating the screen. This configuration enables the target user to select a target battery replacement method for which a reward convenient for the target user is given. As a result, the possibility that the target user replaces the target battery can be improved.
(18) An information processing device according to another aspect of the present disclosure includes: a first acquisition unit that acquires first information on a battery collected by a base; a second acquisition unit that acquires second information on a target battery to be collected; a determination unit that determines whether the target battery is collectable from the base based on the first information and the second information; a third acquisition unit that, when the determination unit determines that the target battery is not collectable from the base, acquires third information on a battery owned by each of one or more users; a specification unit that specifies one or more target users who own the target battery based on the third information; and an output unit that outputs fourth information recommending replacement of the target battery at the base to a terminal device used by each of the one or more target users.

According to this configuration, the same operation and effect as those of the information processing method described in (1) can be obtained.
(19) A non-transitory computer readable storage medium according to still another aspect of the present disclosure is a non-transitory computer readable storage medium storing a control program causes a computer to function as: a first acquisition unit that acquires first information on a battery collected by a base; a second acquisition unit that acquires second information on a target battery to be collected; a determination unit that determines whether the target battery is collectable from the base based on the first information and the second information; a third acquisition unit that, when the determination unit determines that the target battery is not collectable from the base, acquires third information on a battery owned by each of one or more users; a specification unit that specifies one or more target users who own the target battery based on the third information; and an output unit that outputs fourth information recommending replacement of the target battery at the base to a terminal device used by each of the one or more target users.

According to this configuration, the same operation and effect as those of the information processing method described in (1) can be obtained.

The present disclosure can also be implemented as an information processing system that is operated by such a control program. It is needless to say that such a computer program can be distributed via a computer-readable non-transitory recording medium such as a CD-ROM or via a communication network such as the Internet.

Note that all embodiments described below show specific examples of the present disclosure. Numerical values, shapes, constituents, steps, order of steps, and the like described in the embodiments below are merely examples, and are not intended to limit the present disclosure. A constituent element not described in an independent claim representing a highest concept among constituent elements in the embodiments below is described as an optional constituent element. In all the embodiments, content of each of the embodiments can be combined.

### First Embodiment

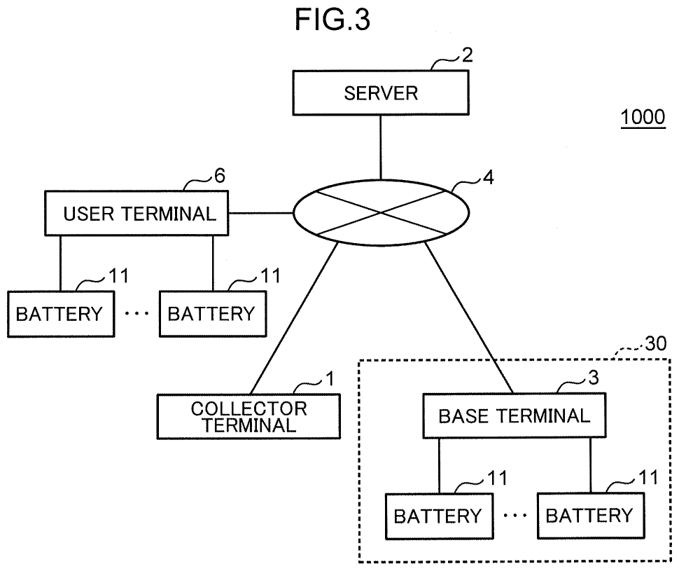

FIG. 3 is a diagram illustrating an overall configuration of an information processing system 1000 according to an embodiment of the present disclosure. The information processing system 1000 includes a server 2 (information processing device), a base terminal 3, a collector terminal 1, and a user terminal 6 (terminal device).

The server 2 is a server device owned by the battery collection intermediary 200 (FIG. 2). The server 2 is communicably connected to the base terminal 3, the collector terminal 1, and the user terminal 6 via a network 4. The network 4 is, for example, a wide-area communication network including the Internet and a mobile phone communication network. In FIG. 3, one user terminal 6, one collector terminal 1, and one base terminal 3 are illustrated, but a plurality of these terminals may be provided. The user terminal 6, the collector terminal 1, and the base terminal 3 are uniquely specified.

The base terminal 3 is installed in the collection base 30 (FIG. 2). The base terminal 3 is an information processing device such as a notebook computer owned by the battery collection intermediary 200 (FIG. 2). The base terminal 3 includes a display that displays various information, a touch panel device that receives various operations, and the like.

In addition, the base terminal 3 includes a communication circuit (not illustrated). The base terminal 3 periodically transmits information (hereinafter, collection state information (first information)) on a battery 11 collected by the collection base 30 to the server 2 via the network 4 using the communication circuit.

Note that, although one collection base 30 is illustrated in FIGS. 2 and 3, a plurality of collection bases 30 may be provided. In addition, a plurality of base terminals 3 may be installed in the collection base 30.

The battery 11 is a chargeable and dischargeable secondary battery such as a lithium ion battery or a nickel hydrogen battery. The battery 11 is detachable from a mobile device such as mobility or a notebook computer. The mobility is, for example, a moving body that travels using electric power of the battery 11 as a power source, such as an electric car, an electric motorcycle, an electric bicycle, or an electric kickboard. At the collection base 30, the battery 11 may be replaced with the battery 11 that has been charged and is being charged. The battery 11 being charged indicates the battery 11 that is under full charge and is being charged to full charge.

The battery 11 includes a communication circuit and a measurement circuit (not illustrated). The communication circuit performs near field communication with a communication circuit included in the base terminal 3. The communication circuit included in the battery 11 may communicate with the server 2 via the network 4. A measurement circuit included in the battery 11 measures a predetermined index representing a state of the battery 11, such as a state of charge (SOC) and a state of health (SOH) of the battery 11. The SOC indicates the charge capacity of the battery 11, and the SOH indicates the ratio of the full charge capacity at the time of deterioration when the initial full charge capacity is set to 100%.

The battery 11 collected by the collection base 30 periodically transmits the model number of the battery 11 and the measurement value such as the SOH of the battery 11 by the measurement circuit included in the battery to the base terminal 3 using the communication circuit included in the battery, for example, once a day. The communication circuit included in the base terminal 3 periodically transmits the collection state information (FIG. 2) including the model number, the measurement value, and the like of the battery 11 received from the battery 11 to the server 2 via the network 4, for example, once a day. Specifically, the collection state information includes the position of the collection base 30, the number of batteries 11 collected by the collection base 30, and the total number of batteries 11 that are collectable in the collection base 30 in addition to the measurement values such as the model number and SOH of the batteries 11 received from the batteries 11 collected by the collection base 30.

The user terminal 6 is a portable information processing device such as a tablet computer and a smartphone used by the user 600 (FIG. 2) registered in the information processing system 1000. The user terminal 6 includes a display that displays various information, a touch panel device that receives various operations, and the like.

Further, the user terminal 6 includes a communication circuit (not illustrated). Using the communication circuit, the user terminal 6 periodically transmits information (hereinafter, user battery information (third information)) on the battery 11 owned by the user 600 to the server 2 via the network 4, for example, once a day. FIG. 3 illustrates an example in which the user 600 owns the plurality of batteries 11, but the number of batteries 11 owned by the user 600 may be one.

The battery 11 owned by the user 600 also periodically transmits the model number of the battery 11 and the measurement value such as the SOH of the battery 11 by the measurement circuit thereof to the user terminal 6 by using the communication circuit thereof, for example, once a day. The communication circuit included in the user terminal 6 periodically transmits the user battery information including the model number and the measurement value of the battery 11 received from the battery 11 to the server 2 via the network 4, for example, once a day. Specifically, the user battery information includes the current location of user terminal 6 in addition to the measurement values such as the model number and SOH of battery 11 received from battery 11 owned by user 600.

The collector terminal 1 is an information processing device such as a notebook computer used by the collection agent 300 (FIG. 2). The collector terminal 1 includes a display that displays various information, a touch panel device that receives various operations, and the like.

The collector terminal 1 includes a communication circuit (not illustrated). The collector terminal 1 transmits information (hereinafter, collection target information (second information)) on the batteries 11 (hereinafter, target battery) to be collected to the server 2 via the network 4 using the communication circuit. The collection target information includes the date on which collection of the target battery is desired (hereinafter, the collection date), the model number of the target battery, the SOH range of the target battery, and the number of target batteries. The collection target information may further include a required time for a collection operation of the target battery. The collection target information is generated by the operation of the collector terminal 1 by the collection agent 300 (FIG. 2).

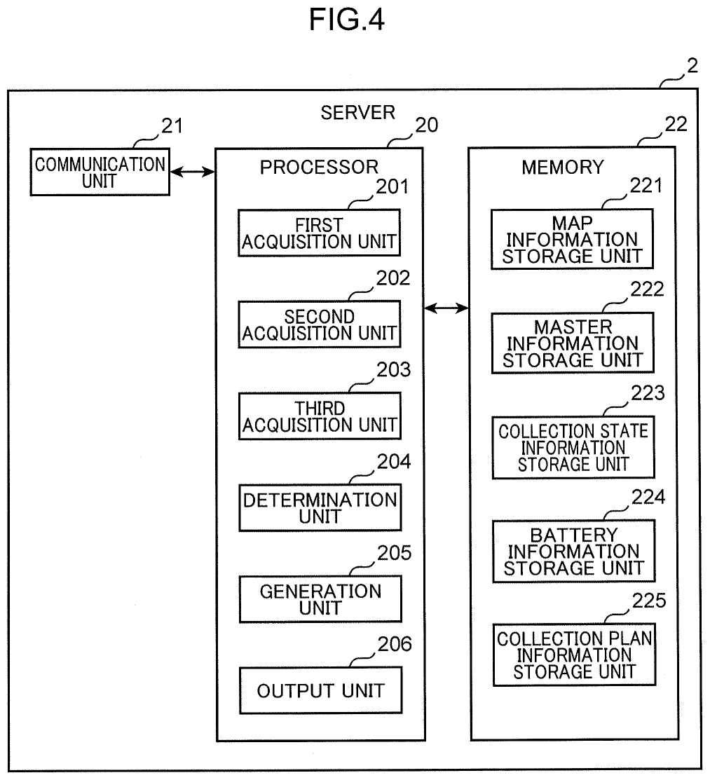

Next, a configuration of the server 2 will be described in detail. FIG. 4 is a diagram illustrating one example of a configuration of the server 2. The server 2 includes a communication unit 21, a memory 22, and a processor 20 (computer).

The communication unit 21 is a communication circuit that connects the server 2 to the network 4. The communication unit 21 receives the collection state information from the base terminal 3. The communication unit 21 receives the collection target information from the collector terminal 1. The communication unit 21 receives the user battery information from the user terminal 6. The communication unit 21 transmits the recommendation information (FIG. 2) to the user terminal 6.

The memory 22 includes, for example, a nonvolatile rewritable semiconductor memory such as a flash memory, a hard disk drive (HDD), or the like. The memory 22 stores a control program executed by the processor 20. The memory 22 includes a map information storage unit 221, a master information storage unit 222, a collection state information storage unit 223, a battery information storage unit 224, and a collection plan information storage unit 225.

The map information storage unit 221 stores information (hereinafter, map information) on each spot in a predetermined area targeted by the information processing system 1000. Each spot in the area is the collection base 30, facilities such as parks and schools existing in the area, and characteristic spots on roads such as intersections and end points of the roads existing in the area. The map information includes a map image indicating a map of the area and information indicating positions of the respective spots in the area. The information indicating the positions of the spots includes latitudes and longitudes of the spots. Note that the information indicating the positions of the spots may further include altitudes of the spots.

The master information storage unit 222 stores information on the user 600, the collection base 30, and the collection agent 300 of the information processing system 1000. Specifically, the master information storage unit 222 stores identification information of the user 600. The master information storage unit 222 stores the identification information of the collection base 30 and the position of the collection base 30. The master information storage unit 222 stores identification information of the collection agent 300 and a position of an office of the collection agent 300.

The collection state information transmitted by the base terminal 3 is stored in the collection state information storage unit 223. The battery information storage unit 224 stores user battery information transmitted by the user terminal 6. The collection plan information storage unit 225 stores collection plan information and provisional collection plan information generated by a generation unit 205 to be described later.

The processor 20 includes, for example, a central processing unit. The processor 20 functions as a first acquisition unit 201, a second acquisition unit 202, a third acquisition unit 203, a determination unit 204, a generation unit 205 (specification unit), and an output unit 206 by executing the control program stored in the memory 22. However, this is an example, and the first acquisition unit 201, the second acquisition unit 202, the third acquisition unit 203, the determination unit 204, the generation unit 205, and the output unit 206 may be realized by a dedicated electric circuit such as an ASIC.

The first acquisition unit 201 acquires the collection state information received by the communication unit 21 from the base terminal 3, and stores the collection state information in the collection state information storage unit 223.

The second acquisition unit 202 acquires the collection target information received by the communication unit 21 from the collector terminal 1.

The third acquisition unit 203 acquires the user battery information received by the communication unit 21 from the user terminal 6, and stores the user battery information in the battery information storage unit 224.

The determination unit 204 determines whether the target battery is collectable from the collection base 30 based on the collection state information stored in the collection state information storage unit 223 and the collection target information acquired by the second acquisition unit 202.

Specifically, the determination unit 204 refers to the information stored in the collection state information storage unit 223 and the collection plan information storage unit 225, and determines whether the total number of target batteries (hereinafter, the total collection number) collectable from the one or more collection bases 30 is equal to or larger than the number of target batteries (hereinafter, the collection number) included in the collection target information.

When determining that the total collection number is equal to or larger than the collection number, the determination unit 204 determines that the target battery is collectable from the collection base 30. In this case, the determination unit 204 prepares a collection plan for collecting the target battery from the collection base 30.

Specifically, the determination unit 204 refers to the information stored in the collection state information storage unit 223 and the collection plan information storage unit 225, and determines, by a predetermined algorithm, one or more collection bases 30 (one or more transit bases) through which the target batteries of the collection number are collected, a route to visit the one or more collection bases 30, and the number of target batteries to be collected by each of the one or more collection bases 30.

The determination unit 204 prepares, as a collection plan, the determined one or more collection bases 30, a route to visit the one or more collection bases 30, the number of target batteries to be collected by each of the one or more collection bases 30, and a plan confirmation deadline. The determination unit 204 stores information indicating the collection plan (hereinafter, collection plan information) in the collection plan information storage unit 225. The plan confirmation deadline indicates a deadline for determining the collection plan indicated by the collection plan information. The determination unit 204 determines a date earlier than the collection date included in the collection target information by a predetermined number of days as the plan confirmation deadline. Note that the present invention is not limited thereto, and the plan confirmation deadline may be included in the collection target information, and the determination unit 204 may acquire the plan confirmation deadline from the collection target information when preparing the collection plan.

On the other hand, when determining that the total collection number is less than the collection number, the determination unit 204 determines that the target battery is not collectable from the collection base 30. In this case, the determination unit 204 prepares a temporary collection plan (hereinafter, provisional collection plan) for collecting the target battery from the collection base 30.

Specifically, the determination unit 204 refers to the information stored in the collection state information storage unit 223 and the collection plan information storage unit 225, and determines, by a predetermined algorithm, one or more collection bases 30 (one or more transit bases) through which the target batteries of the total collection number are collected, a route (collection route) to visit the one or more collection bases 30, and the number of target batteries to be collected by each of the one or more collection bases 30.

As described above, even when the total collection number is less than the collection number and it is determined that the target batteries are not collectable from the collection bases 30, the determination unit 204 determines one or more collection bases 30 through which the target batteries of the total collection number are collected. As a result, when the target batteries are collectable from the collection bases 30, the determination unit 204 can omit recalculation of one or more collection bases 30 through which the target batteries of the total collection number are collected.

The determination unit 204 prepares, as a provisional collection plan, the determined one or more collection bases 30, a route to visit the one or more collection bases 30, the number of target batteries to be collected by each of the one or more collection bases 30, and a plan confirmation deadline. The determination unit 204 stores information indicating the provisional collection plan (hereinafter, provisional collection plan information) in the collection plan information storage unit 225.

When the determination unit 204 determines that the target battery is not collectable from the collection base 30, the generation unit 205 specifies one or more users 600 (hereinafter, target user) who own the target battery based on the user battery information stored in the battery information storage unit 224.

Further, the generation unit 205 generates recommendation information (FIG. 2, fourth information) for recommending replacement of the target battery in the collection base 30. Details of the recommendation information will be described later.

When the determination unit 204 determines that the target battery is collectable, the output unit 206 transmits (outputs) the collection plan information indicating the collection plan prepared by the determination unit 204 to the collector terminal 1 (terminal device used by the provider of the second information) as the transmission source of the collection target information.

On the other hand, when the determination unit 204 determines that the target battery is not collectable from the collection base 30, the output unit 206 transmits (outputs) the provisional collection plan information indicating the provisional collection plan prepared by the determination unit 204 to the collector terminal 1. In this case, the output unit 206 transmits (outputs) the recommendation information generated by the generation unit 205 to the user terminal 6 used by each of the one or more target users specified by the generation unit 205.

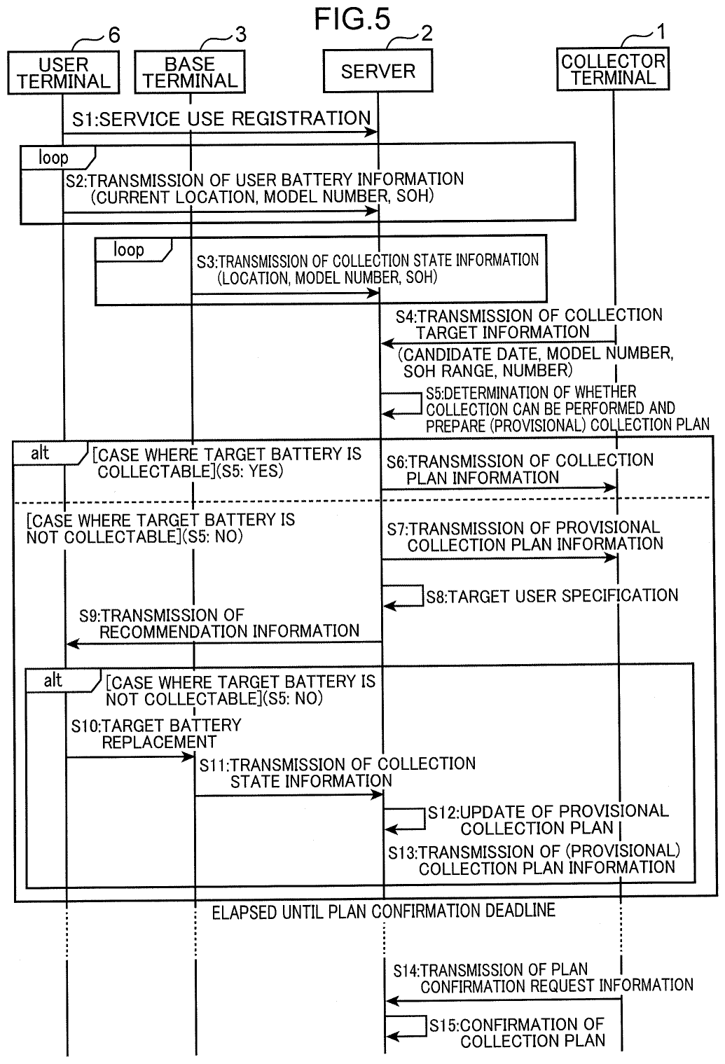

The configuration of the server 2 has been described above. Subsequently, processing performed in the information processing system 1000 will be described. FIG. 5 is a sequence diagram illustrating an example of processing performed in the information processing system 1000.
(Step S1) First, the use of the information processing system 1000 is registered by the operation of the user terminal 6 by the user 600 of the information processing system 1000.

Specifically, the user 600 operates the user terminal 6 to transmit information (hereinafter, the registration request information) requesting use registration of the information processing system 1000 to the server 2. The registration request information includes identification information of the user 600. In the server 2, when the communication unit 21 receives the registration request information, the processor 20 stores the identification information of the user 600 included in the registration request information in the master information storage unit 222.
(Step S2) The user terminal 6 periodically transmits user battery information on the battery 11 owned by the user 600 to the server 2. In the server 2, when the communication unit 21 receives the user battery information, the third acquisition unit 203 stores the user battery information in the battery information storage unit 224.
(Step S3) In the collection base 30, the base terminal 3 periodically transmits the collection state information including the model number and the measurement value of the battery 11 received from the battery 11 collected by the collection base 30 to the server 2. In the server 2, when the communication unit 21 receives the collection state information, the first acquisition unit 201 stores the collection state information in the collection state information storage unit 223.
(Step S4) The collection agent 300 operates the collector terminal 1 to transmit collection target information on the target battery, which is the battery 11 to be collected, to the server 2. In the server 2, when the communication unit 21 receives the collection target information, the second acquisition unit 202 acquires the collection target information.
(Step S5) The determination unit 204 determines whether the target battery is collectable from the collection base 30 based on the collection state information stored in the collection state information storage unit 223 and the collection target information acquired in step S4, and prepares a collection plan or a provisional collection plan.

When the determination unit 204 determines that the target battery is collectable from the collection base 30 (YES in step S5), the output unit 206 stores collection plan information indicating the collection plan prepared by the determination unit 204 in the collection plan information storage unit 225, and transmits the collection plan information to the collector terminal 1 (step S6).

When the determination unit 204 determines that the target battery is not collectable from the collection base 30 (NO in step S5), the output unit 206 stores the provisional collection plan information indicating the provisional collection plan prepared by the determination unit 204 in the collection plan information storage unit 225, and transmits the provisional collection plan information to the collector terminal 1 (step S7).

On the other hand, when the determination unit 204 determines that the target battery is not collectable from the collection base 30 (NO in step S5), the generation unit 205 specifies one or more target users who own the target battery based on the user battery information stored in the battery information storage unit 224. In addition, the generation unit 205 generates recommendation information for recommending replacement of the target battery in the collection base 30 (step S8). The output unit 206 transmits the recommendation information generated by the generation unit 205 to the user terminal 6 used by each of the one or more target users using the communication unit 21 (step S9).

After the determination unit 204 determines that the target battery is not collectable from the collection base 30 (NO in step S5), it is assumed that the user 600 replaces the target battery in the collection base 30 (step S10). Thereafter, it is assumed that the base terminal 3 transmits the collection state information related to the target battery collected by the collection base 30 to the server 2, and in the server 2, the first acquisition unit 201 stores the collection state information in the collection state information storage unit 223 (step S11).

In this case, the determination unit 204 updates the provisional collection plan (hereinafter, provisional target plan) indicated by the provisional collection plan information on the target battery stored in the collection plan information storage unit 225 (step S12).

Specifically, in step S12, as in step S5, the determination unit 204 determines whether the target battery is collectable from the collection base 30 based on the collection state information stored in the collection state information storage unit 223 and the collection target information transmitted in step S4, and prepares a collection plan or a provisional collection plan.

When the determination unit 204 determines that the target battery is collectable from the collection base 30 and prepares the collection plan, the output unit 206 stores collection plan information indicating the collection plan in the collection plan information storage unit 225, and deletes the provisional collection plan information indicating the provisional target plan stored in the collection plan information storage unit 225. In addition, the output unit 206 transmits the collection plan information to the collector terminal 1 together with information indicating that the provisional target plan has been improved (hereinafter, plan improvement information) (step S13).

On the other hand, it is assumed that in step S12, the determination unit 204 determines that the target battery is not collectable from the collection base 30 and prepares the provisional collection plan. In this case, the output unit 206 compares the content of the provisional collection plan prepared this time with the content of the provisional target plan. When the content of the provisional collection plan prepared this time is different from the content of the provisional target plan, the output unit 206 updates the provisional collection plan information indicating the provisional target plan stored in the collection plan information storage unit 225 with the provisional collection plan information indicating the provisional collection plan prepared this time. In addition, the output unit 206 transmits the provisional collection plan information indicating the provisional collection plan prepared this time to the collector terminal 1 together with the plan improvement information (step S13). When the content of the provisional collection plan prepared this time is the same as the content of the provisional target plan, the output unit 206 does not update the provisional collection plan information indicating the provisional target plan.

Thereafter, it is assumed that until the plan confirmation deadline included in the collection plan indicated by the collection plan information or the provisional collection plan indicated by the provisional collection plan information stored in the collection plan information storage unit 225 arrives, information requesting confirmation of the collection plan (hereinafter, plan confirmation request information) is transmitted from the collector terminal 1 to the server 2 (step S14).

In this case, the output unit 206 confirms the collection plan indicated by the collection plan information or the provisional collection plan indicated by the provisional collection plan information stored in the collection plan information storage unit 225 (step S15). For example, in step S15, the output unit 206 stores the collection target information acquired by the second acquisition unit 202 in step S4 in the collection plan information storage unit 225 in association with the collection plan information indicating the determined collection plan or the provisional collection plan information indicating the determined provisional collection plan.

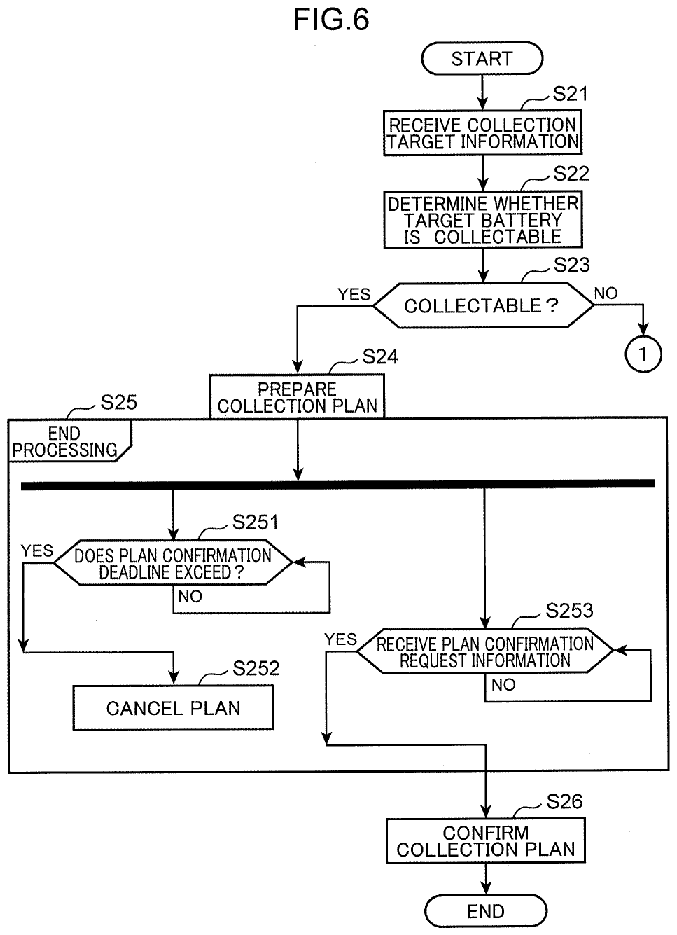

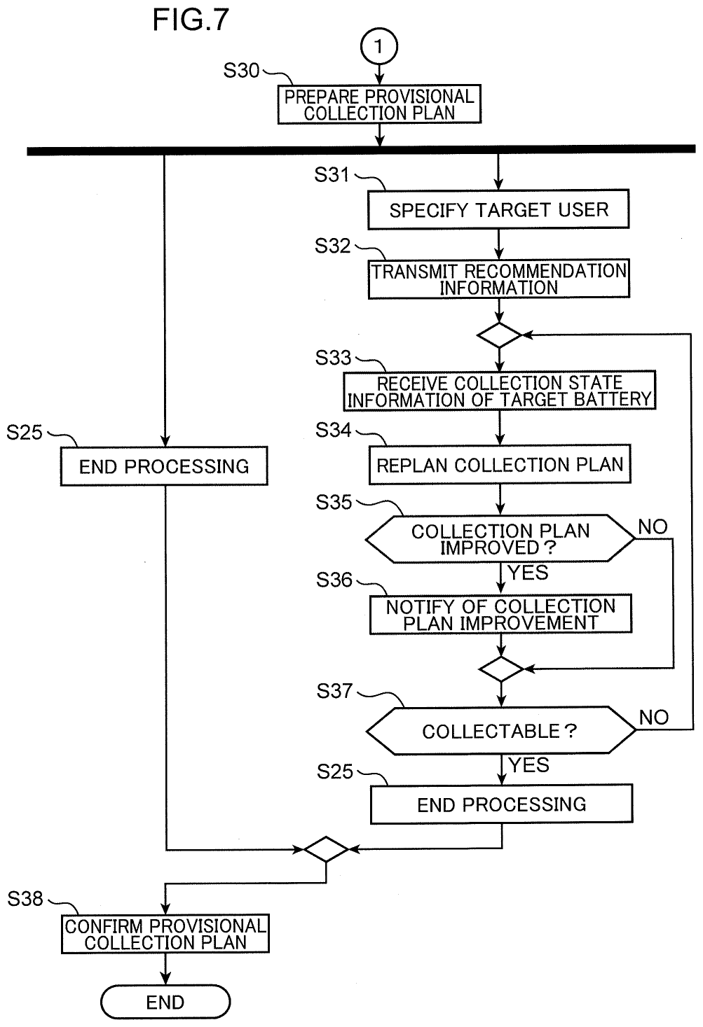

Next, processing of the server 2 will be described. FIGS. 6 and 7 are flowcharts presenting an example of the processing of the server 2.

In the server 2, when the communication unit 21 receives the collection target information from the collector terminal 1, the second acquisition unit 202 acquires the collection target information (step S21). Step S21 corresponds to step S4 illustrated in FIG. 5.

Next, the determination unit 204 determines whether the target battery is collectable from the collection base 30 based on the collection state information stored in the collection state information storage unit 223 and the collection target information acquired in step S21 (step S22). When it is determined that the target battery is collectable from the collection base 30 (YES in step S23), the determination unit 204 prepares a collection plan for collecting the target battery from the collection base 30, transmits collection plan information indicating the collection plan to the collector terminal 1, and stores the collection plan information in the collection plan information storage unit 225 (step S24). Steps S22 to S24 correspond to steps S5 to S6 illustrated in FIG. 5.

After step S24, predetermined end processing for confirming or canceling the collection plan or the provisional collection plan prepared by the determination unit 204 is performed (step S25).

In the end processing, the output unit 206 waits until the plan confirmation deadline included in the collection plan or the provisional collection plan indicated by the collection plan information or the provisional collection plan information stored in the collection plan information storage unit 225 exceeds (NO in step S251).

When the plan confirmation deadline exceeds (YES in step S251), the output unit 206 deletes the collection plan information or the provisional collection plan information stored in the collection plan information storage unit 225. As a result, the output unit 206 cancels the collection plan or the provisional collection plan indicated by the collection plan information or the provisional collection plan information (step S252).

Furthermore, in the end processing, the output unit 206 waits until the communication unit 21 receives the plan confirmation request information (NO in step S253).

When the communication unit 21 receives the plan confirmation request information (YES in step S253), the output unit 206 confirms the collection plan indicated by the collection plan information stored in the collection plan information storage unit 225 (step S26). Step S253 corresponds to step S14 illustrated in FIG. 5, and step S26 corresponds to step S15 illustrated in FIG. 5.

On the other hand, as illustrated in FIG. 7, when determining that the target battery is not collectable from the collection base 30 (NO in step S23), the determination unit 204 prepares a provisional collection plan for collecting the target battery from the collection base 30 (step S30).

After step S30, step S25 (FIG. 7) and the processing after step S31 are performed in parallel.

In step S31, the generation unit 205 specifies one or more target users who own the target battery based on the user battery information stored in the battery information storage unit 224, and generates the recommendation information (step S31). The output unit 206 transmits the recommendation information generated in step S31 to the user terminal 6 used by each of the one or more target users (step S32). Steps S31 to S32 correspond to steps S8 to S9 illustrated in FIG. 5.

Thereafter, when the target battery is replaced in the collection base 30 and the communication unit 21 receives the collection state information on the target battery, the first acquisition unit 201 acquires the collection state information from the communication unit 21 and stores the collection state information in the collection state information storage unit 223 (step S33).

In this case, the determination unit 204 updates the provisional target plan indicated by the provisional collection plan information stored in the collection plan information storage unit 225 (step S34). Step S34 corresponds to step S12 illustrated in FIG. 5. That is, in step S34, the determination unit 204 determines whether the target battery is collectable from the collection base 30 based on the collection state information stored in the collection state information storage unit 223 and the collection target information acquired in step S21 (FIG. 6), and prepares a collection plan or a provisional collection plan.

Next, the output unit 206 determines whether the provisional target plan has been improved (step S35). Specifically, when the collection plan is prepared in step S34, the output unit 206 determines that the provisional target plan has been improved (YES in step S35). In this case, the output unit 206 stores the collection plan information indicating the collection plan in the collection plan information storage unit 225, and deletes the provisional collection plan information indicating the provisional target plan stored in the collection plan information storage unit 225. In addition, the output unit 206 transmits the collection plan information together with the plan improvement information to the collector terminal 1 (step S36).

On the other hand, when the provisional collection plan is prepared in step S34, the output unit 206 compares the content of the provisional collection plan with the content of the provisional target plan. The output unit 206 also determines that the provisional target plan has been improved when the content of the provisional collection plan is different from the content of the provisional target plan (YES in step S35). In this case, the output unit 206 updates the provisional collection plan information indicating the provisional target plan stored in the collection plan information storage unit 225 with the provisional collection plan information indicating the provisional collection plan, and transmits the provisional collection plan information together with the plan improvement information to the collector terminal 1 (step S36).

Furthermore, in a case where the provisional collection plan has been prepared in step S34, but the content of the provisional collection plan is the same as the content of the provisional target plan, the output unit 206 determines that the provisional target plan has not been improved (NO in step S35). In this case, the output unit 206 does not perform step S36.

It is assumed that the output unit 206 has not performed step S36 and that the output unit 206 has transmitted not the collection plan information but the provisional collection plan information in step S36. In this case, the determination unit 204 determines that the target battery is collectable from the collection base 30, and accordingly, the processing in and after step S33 is repeated until the output unit 206 transmits the collection plan information indicating the collection plan (NO in step S37).

On the other hand, when the determination unit 204 determines that the target battery is collectable from the collection base 30 and the output unit 206 transmits the collection plan information accordingly (YES in step S37), step S25 (FIG. 7) is performed. When the communication unit 21 receives the plan confirmation request information in step S25 (FIG. 7) (YES in step S253 (FIG. 7)), step S38 is performed. Furthermore, in step S25 (FIG. 7) after step S30, when the communication unit 21 receives the plan confirmation request information (YES in step S253 (FIG. 7)), step S38 is performed.

In step S38, the output unit 206 confirms the provisional collection plan indicated by the provisional collection plan information stored in the collection plan information storage unit 225 (step S38). Step S38 corresponds to step S15 illustrated in FIG. 5.

Next, the recommendation information generated by the generation unit 205 will be described. After specifying one or more target users who own the target battery, the generation unit 205 generates recommendation information to be transmitted to the user terminal 6 used by each target user. The generation unit 205 generates the recommendation information with reference to the collection target information acquired by the second acquisition unit 202, the provisional collection plan information stored in the collection plan information storage unit 225 by the determination unit 204, and information stored in the map information storage unit 221, the master information storage unit 222, and the battery information storage unit 224.

The recommendation information includes information (hereinafter, reward information) indicating a reward given to each target user when the target battery is replaced in the collection base 30.

Specifically, the generation unit 205 calculates a higher reward (hereinafter, the first reward) as a matching degree between the collection target information acquired by the second acquisition unit 202 and the information on the target battery owned by each target user stored in the battery information storage unit 224 is higher.

For example, the generation unit 205 calculates the first reward assuming that the matching degree is higher as the SOH (hereinafter, the target SOH) of the target battery owned by each target user stored in the battery information storage unit 224 falls within the range of the SOH of the target battery included in the collection target information acquired by the second acquisition unit 202 and is closer to the upper limit value of the range. For example, the generation unit 205 calculates the first reward using the following expression.

$$[ Math . 1 ]$$

$$I ( x ) = \{ \begin{matrix}{p}_{m i n} + ( x - {x}_{m i n} ) \times ( {p}_{m ax} - {p}_{m i n} ) / ( {x}_{m ax} - {x}_{m i n} ) & ( {x}_{m i n} \leq x \leq {x}_{m ax} ) \\ 0 & ( x < {x}_{m i n} ) \\ 0 & ( x > {x}_{m ax} )\end{matrix}$$

In the above expression, x represents a target SOH, and I(x) represents the first reward when the target SOH is x. pmin is a constant indicating a lower limit value of the reward, and pmax is a constant indicating an upper limit value of the reward. xmin is a lower limit value of the range of the SOH of the target battery, and xmax is an upper limit value of the range. For convenience of description, in the following description, it is assumed that pmin is 1 and pmax is 100. However, pmin is not limited to 1, and pmax is not limited to 100. It is sufficient that pmin and pmax are positive numbers and pmin is smaller than pmax.

Therefore, when the target SOH is outside the range of the SOH of the target battery included in the collection target information acquired by the second acquisition unit 202, the generation unit 205 calculates the first reward as “0”. However, the first reward calculated by the generation unit 205 when the SOH of the target battery included in the collection target information acquired by the second acquisition unit 202 falls outside the range is not limited to “0”, and may be, for example, a value smaller than the minimum value of the first reward calculated when the target SOH falls within the range.

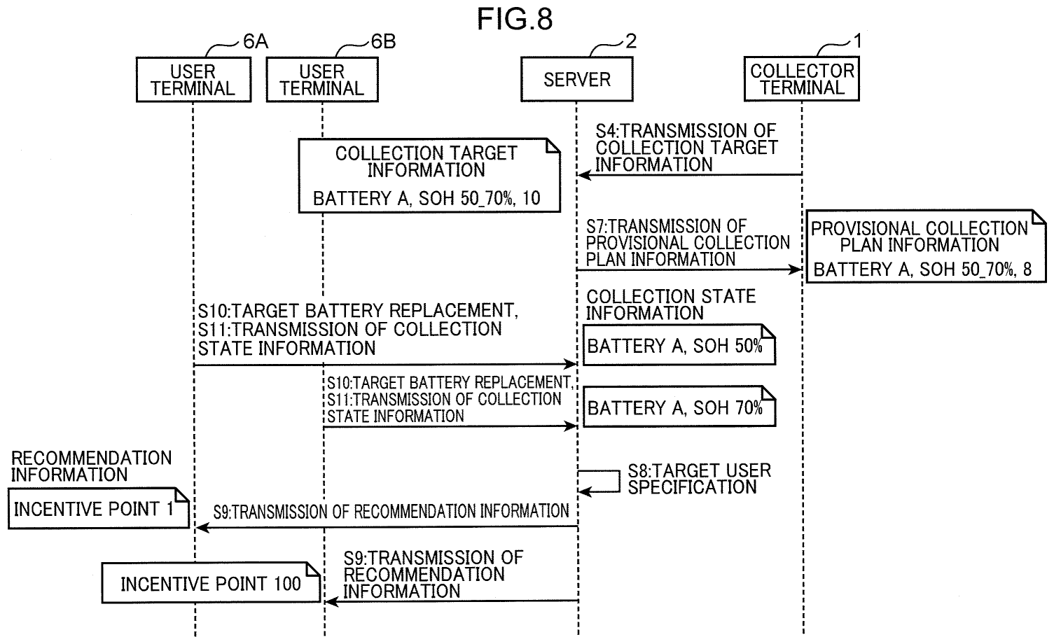

FIG. 8 is a sequence diagram illustrating an example of processing when the recommendation information including the first reward is output. FIG. 8 illustrates a part of the processing illustrated in FIG. 5. For example, in step S4, it is assumed that the second acquisition unit 202 acquires the collection target information including the model number “Battery A” of the target battery, the range “50 to 70%” of the SOH of the target battery, and the number “10” of the target batteries. That is, it is assumed that the collection agent 300 desires to collect “10” target batteries whose model number is “Battery A” and whose SOH range is “50 to 70%”.

Accordingly, in step S7, it is assumed that the determination unit 204 has prepared a provisional collection plan for collecting only the total collection number of “8” target batteries whose model number is “Battery A” and whose SOH range is “50 to 70%” from the collection base 30. Then, it is assumed that the determination unit 204 stores the provisional collection plan information indicating the provisional collection plan in the collection plan information storage unit 225 and transmits the provisional collection plan information to the collector terminal 1.

In addition, it is assumed that the model number “Battery A” of the target battery and the target SOH “50%” are included in the user battery information which is acquired by the third acquisition unit 203 from a user terminal 6A and stored in the battery information storage unit 224 in step S2. In addition, it is assumed that the model number “Battery A” of the target battery and the target SOH “70%” are included in the user battery information which is acquired by the third acquisition unit 203 from a user terminal 6B and stored in the battery information storage unit 224 in step S2. Accordingly, in step S8, it is assumed that the generation unit 205 specifies the users 600 of the user terminal 6A and the user terminal 6B as the target users.

In this case, the target SOH “50%” included in the user battery information acquired from the user terminal 6A is within the range “50 to 70%” of the SOH of the target battery included in the collection target information. Therefore, the generation unit 205 substitutes “50” to x in the above expression, substitutes “50” to xmin, and substitutes “70” to xmax, and calculates a first reward I(50) included in the recommendation information to be transmitted to the user terminal 6A as “1 (=1+(50−50)*(100−1)/(70−50))”.

The target SOH “70%” included in the user battery information acquired from the user terminal 6B falls within the range “50 to 70%” of the SOH of the target battery included in the collection target information. Therefore, the generation unit 205 substitutes “70” to x, substitutes “50” to xmin, and substitutes “70” to xmax in the above expression, and calculates the first reward I(70) included in the recommendation information to be transmitted to the user terminal 6B as “100(=1+(70−50)*(100−1)/(70−50))”.

In this case, for example, in step S9, the recommendation information including the reward information “incentive point 1” indicating the first reward “1” is transmitted to the user terminal 6A, and the recommendation information including the reward information “incentive point 100” indicating the first reward “100” is transmitted to the user terminal 6B.

As a result, it is possible to notify the target user whose SOH of the owned target battery falls within the range of the SOH of the target battery included in the collection target information and is close to the upper limit value of the range that a high first reward is given when the target battery is replaced in the collection base 30.

Note that, for example, the user battery information may include other information related to the battery 11 owned by the user 600, and the collection target information may include information that can be compared with the other information. In accordance with this, the generation unit 205 may calculate a higher first reward as the matching degree between the other information and the comparable information is higher.

The generation unit 205 may further generate, as the recommendation information, a map image on which the current location of the target user, positions of one or more display bases existing within a predetermined distance from the current location of the target user among the one or more collection bases 30, a collection date of the target battery, a model number of the target battery, the first reward, an icon indicating a display base closest to the current location of each target user among the one or more display bases, and an icon indicating a display base group of the one or more display bases to which the reward is given to the target user by replacement of the target battery are displayed.

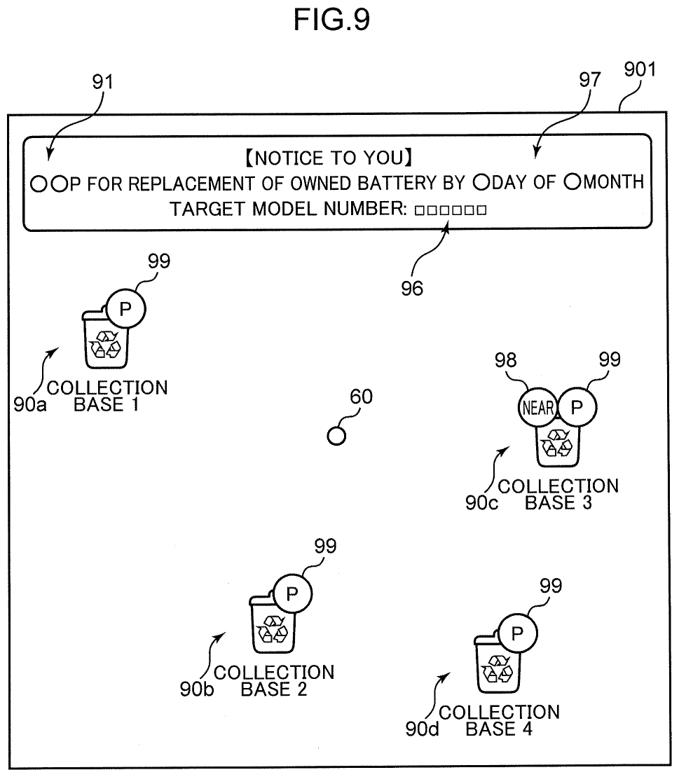

FIG. 9 is a diagram illustrating an example of a map image 901 including a first reward 91. For example, the generation unit 205 generates the map image 901 illustrated in FIG. 9. The map image 901 illustrates an example in which a current location 60 of the target user, the positions 90a, 90b, 90c, and 90d of the four display bases existing within the predetermined distance from the current location 60 of the target user, the collection date 97 of the target battery, a model number 96 of the target battery, the first reward 91, an icon 98 indicating the display base closest to the current location 60 of each target user, and an icon 99 indicating the display base group to which the reward is given to the target user by replacement of the target battery are superimposed and displayed on the map image within the range within the predetermined distance from the current location 60 of the target user.

In this case, by referring to the map image 901 on the user terminal 6, the target user can determine by when, at which collection base 30 existing within a predetermined distance and which battery 11 should be replaced to obtain the first reward 91 by the least movement.

Note that the generation unit 205 may simplify the map image 901. For example, the generation unit 205 may not display one or more of the collection date 97 of the target battery, the model number 96 of the target battery, and the icon 98 indicating the display base closest to the current location 60 of each target user on the map image 901. In this case, the target user can determine at least in which collection base 30 existing within a predetermined distance the first reward 91 can be obtained by replacing the battery 11 by referring to the map image on the user terminal 6.

In addition, instead of the icon 99 indicating the display base group to which the reward is given to the target user by the replace of the first reward and the target battery, the generation unit 205 may display, on the map image 901, information indicating whether each display base is a base to which the first reward is given to each target user by the replace of the target battery, such as a message “The collection base to which the first reward “○○P” is given is “collection base 1, collection base 2, collection base 3, collection base 4”.

As described above, according to the first embodiment, it is possible to determine whether the target battery is collectable from the collection base 30 in consideration of the battery 11 collected by the collection base 30. When the target battery is not collectable from the collection base 30, the target user who owns the target battery is specified based on the user battery information acquired from the user terminal 6, and the recommendation information is output to the user terminal 6 used by the target user. Therefore, the possibility that the user 600 replaces the target battery in the collection base 30 can be improved in consideration of not only the battery 11 collected by the collection base 30 but also the battery 11 owned by the user 600. As a result, the possibility of collecting the target battery in the collection base 30 is improved, and the target battery can be efficiently collected.

### Second Embodiment

In the first embodiment, the higher the matching degree between the collection target information acquired by the second acquisition unit 202 and the information on the target battery owned by each target user stored in the battery information storage unit 224, the higher the first reward is included in the recommendation information.

In the second embodiment, the recommendation information includes a second reward that is included in the provisional collection plan and given to each target user when the target battery is replaced at the base through which the target battery is collected. Hereinafter, the second embodiment will be described in detail. Note that in the second embodiment, the same components as those in the first embodiment are denoted by the same reference numerals, and description thereof will be omitted.

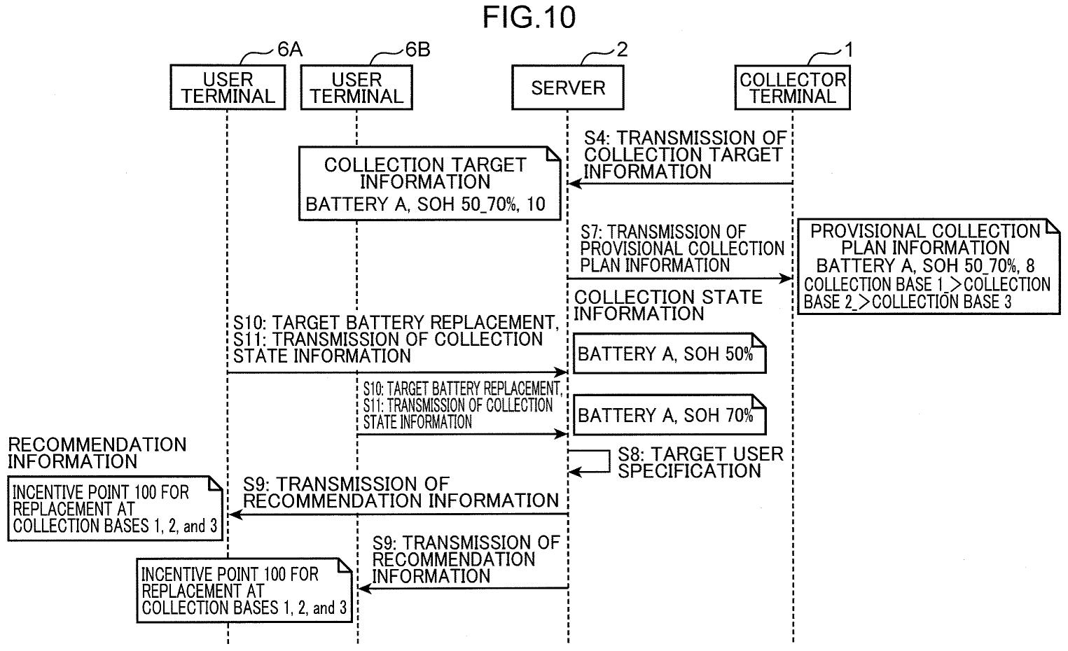

FIG. 10 is a sequence diagram illustrating an example of processing when the recommendation information including the second reward is output. FIG. 10 illustrates a part of the processing illustrated in FIG. 5. For example, in step S4, it is assumed that the second acquisition unit 202 acquires the collection target information including the model number “Battery A” of the target battery, the range “50 to 70%” of the SOH of the target battery, and the number “10” of the target batteries.

Accordingly, in step S7, it is assumed that the determination unit 204 prepares a provisional collection plan to visit three transit bases “collection base 1”, “collection base 2”, and “collection base 3” in order to collect only the total collection number of “8” target batteries whose SOH range is “50 to 70%” and whose model number is “Battery A”. Then, it is assumed that the determination unit 204 stores the provisional collection plan information indicating the provisional collection plan in the collection plan information storage unit 225 and transmits the provisional collection plan information to the collector terminal 1.

In addition, it is assumed that the model number “Battery A” of the target battery and the target SOH “50%” are included in the user battery information which is acquired by the third acquisition unit 203 from a user terminal 6A and stored in the battery information storage unit 224 in step S2. In addition, it is assumed that the model number “Battery A” of the target battery and the target SOH “70%” are included in the user battery information which is acquired by the third acquisition unit 203 from a user terminal 6B and stored in the battery information storage unit 224 in step S2. Accordingly, in step S8, it is assumed that the generation unit 205 specifies the users 600 of the user terminal 6A and the user terminal 6B as the target users.

In this case, the generation unit 205 sets, to a predetermined value “100”, the second reward given to each target user when the target battery is replaced in the three transit bases “collection bases 1”, “collection bases 2”, and “collection bases 3” through which the target battery is collected.

In this case, for example, in step S9, recommendation information including reward information “incentive point 100 for replace at collection bases 1, 2, and 3” indicating the second reward “100” given to each target user when the target battery is replaced in the three transit bases “collection base 1”, “collection base 2”, and “collection base 3” is transmitted to the user terminal 6A and the user terminal 6B. As a result, it is possible to notify the target user that the second reward “100” is given in a case where the target battery is replaced at one or more transit bases through which the target user passes to collect the target batteries of the total collection number.

The generation unit 205 further generates, as the recommendation information, a map image on which the current location of the target user, positions of one or more display bases existing within a predetermined distance from the current location of the target user among the one or more collection bases 30 existing in the information processing system 1000, a collection date of the target battery, a model number of the target battery, the second reward, a route (collection route) to visit each display base included also in the one or more transit bases among the one or more display bases, an icon indicating a display base closest to the current location of each target user, and an icon indicating a display base group of the one or more display bases to which a reward is given to the target user by replacement of the target battery are displayed.

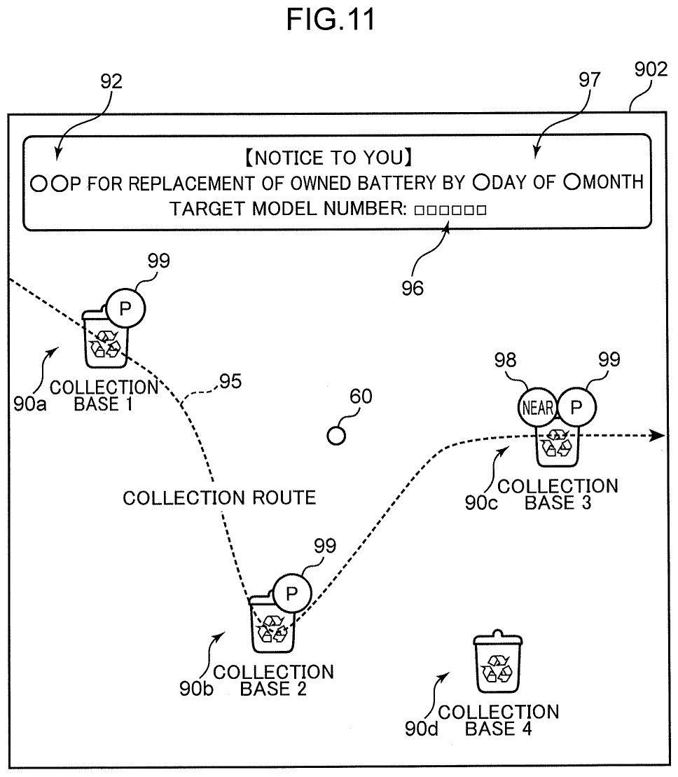

FIG. 11 is a diagram illustrating an example of a map image 902 including a second reward 92. For example, the generation unit 205 generates the map image 902 illustrated in FIG. 11. The map image 902 illustrates an example in which a current location 60 of the target user, positions 90a, 90b, 90c, and 90d of four display bases existing within a predetermined distance from the current location 60 of the target user, a collection date 97 of the target battery, a model number 96 of the target battery, a second reward 92, a route 95 to visit each display base included in the one or more transit bases among the four display bases, an icon 98 indicating a display base closest to the current location 60 of each target user, and an icon 99 indicating a display base group to which a reward is given to the target user by replacement of the target battery are superimposed and displayed on a map image within a range within a predetermined distance from the current location 60 of the target user.

In this case, by referring to the map image 902 on the user terminal 6, the target user can determine by which time, at which collection base 30 on the movement route for collecting the battery 11, and which battery 11 should be replaced to obtain the second reward 92 with the least movement.

Note that, instead of setting the second reward to a predetermined value, the generation unit 205 may set the second reward to the same value as the first reward described in the first embodiment, or may set the second reward to a sum or a product of the first reward and a predetermined value.

In addition, the generation unit 205 may simplify the map image 902. For example, the generation unit 205 may not display one or more of the collection date 97 of the target battery, the model number 96 of the target battery, and the icon 98 indicating the display base closest to the current location 60 of each target user on the map image 902. In this case, the target user can determine at least in which collection base 30 on the route displayed on the map image the battery 11 is replaced to obtain the second reward 92 by referring to the map image.

In addition, instead of the icon 99 indicating the display base group to which the reward is given to the target user by the replace of the second reward and the target battery, the generation unit 205 may display, on the map image 902, information indicating whether each display base is a base to which the second reward is given to each target user by the replace of the target battery, such as a message “The collection base to which the second reward “○○P” is given is “collection base 1, collection base 2, collection base 3”.

### Third Embodiment

In a third embodiment, unlike the first embodiment and the second embodiment, the recommendation information includes a third reward given to each target user when the target battery is replaced in the collection base group in which the operation rate satisfying a predetermined condition is calculated. The operation rate is a ratio of the number of batteries 11 collected by each collection base 30 to the total number of batteries 11 that are collectable by each collection base 30. Hereinafter, the third embodiment will be described in detail. Note that in the second embodiment, the same components as those in the first embodiment are denoted by the same reference numerals, and description thereof will be omitted.

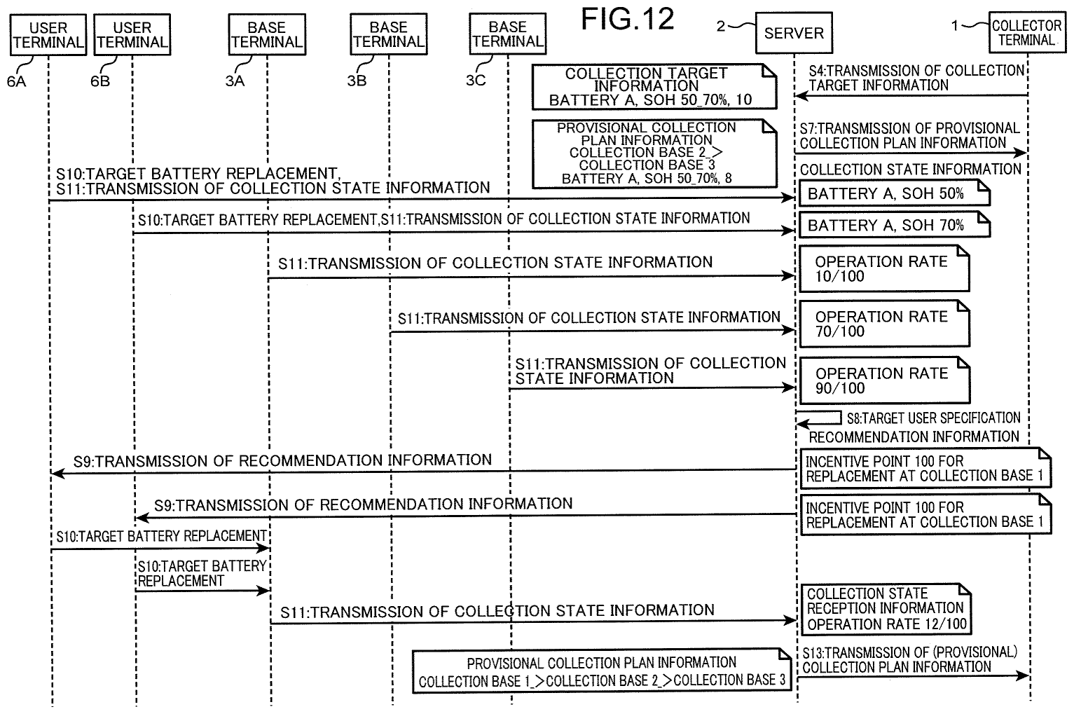

FIG. 12 is a sequence diagram illustrating an example of processing when the recommendation information including the third reward is output. FIG. 12 illustrates a part of the processing illustrated in FIG. 5. For example, in step S4, it is assumed that the second acquisition unit 202 acquires the collection target information including the model number “Battery A” of the target battery, the range “50 to 70%” of the SOH of the target battery, and the number “10” of the target batteries. In addition, it is assumed that there are three collection bases 30 “collection base 1”, “collection base 2”, and “collection base 3” in the information processing system 1000.

Accordingly, in step S7, it is assumed that the determination unit 204 has prepared a provisional collection plan to sequentially visit two transit bases “collection bases 2” and “collection bases 3” among one or more collection bases 30 in order to collect a total collection number of “8” target batteries whose SOH range is “50 to 70%” and whose model number is “Battery A”. Then, it is assumed that the determination unit 204 stores the provisional collection plan information indicating the provisional collection plan in the collection plan information storage unit 225 and transmits the provisional collection plan information to the collector terminal 1.

In addition, it is assumed that the model number “Battery A” of the target battery and the target SOH “50%” are included in the user battery information which is acquired by the third acquisition unit 203 from a user terminal 6A and stored in the battery information storage unit 224 in step S2. In addition, it is assumed that the model number “Battery A” of the target battery and the target SOH “70%” are included in the user battery information which is acquired by the third acquisition unit 203 from a user terminal 6B and stored in the battery information storage unit 224 in step S2. Accordingly, in step S8, it is assumed that the generation unit 205 specifies the users 600 of the user terminal 6A and the user terminal 6B as the target users.

In addition, it is assumed that the collection state information acquired by the first acquisition unit 201 from a base terminal 3A of the collection base 30 “collection base 1” and stored in the collection state information storage unit 223 in step S11 includes the number “10” of batteries 11 collected by the collection base 30 and the total number “100” of batteries 11 that are collectable in the collection base 30. In this case, the generation unit 205 calculates the operation rate of the collection base 30 “collection base 1” as “ 10/100”. Similarly, it is assumed that the generation unit 205 calculates the operation rate of the collection base 30 “collection base 2” as “ 70/100” and calculates the operation rate of the collection base 30 “collection base 3” as “ 90/100”.

In this case, for example, the generation unit 205 sets the third reward given to each target user when the target battery is replaced in the collection base 30 “collection base 1” in which the operation rate satisfying the predetermined condition “the operation rate is lowest among the one or more collection bases 30 existing in the information processing system 1000” is calculated, to a predetermined value “100”.

In this case, in step S9, for example, recommendation information including reward information “incentive point 100 for replace in collection base 1” indicating a third reward “100” given to each target user when the target battery is replaced in the collection base 30 “collection base 1” is transmitted to the user terminal 6A and the user terminal 6B. As a result, it is possible to notify the target user that the third reward “100” is given when the target battery is replaced in the collection base 30 “collection base 1” in which the lowest operation rate is calculated.

FIG. 12 illustrates an example in which the users 600 of the user terminal 6A and the user terminal 6B replace the target battery in the collection base 30 “collection base 1” after the above recommendation information is transmitted. That is, the collection state information acquired by the first acquisition unit 201 from the base terminal 3A of the collection base 30 “collection base 1” in step S11 includes the number “12” of batteries 11 collected by the collection base 30 and the total number “100” of batteries 11 that are collectable in the collection base 30. In this case, the operation rate of the collection base 30 “collection base 1” is updated to “ 12/100”.

In addition, in step S12 (FIG. 5), in order to collect “10” target batteries whose model number is “Battery A” and whose SOH range is “50 to 70%”, a collection plan to visit three transit bases “collection base 1”, “collection base 2”, and “collection base 3” in order is prepared. Then, the collection plan information indicating the collection plan is transmitted to the collector terminal 1.

The generation unit 205 further generates a map image on which the current location of the target user, the positions of one or more display bases existing within a predetermined distance from the current location of the target user among the one or more collection bases 30 existing in the information processing system 1000, the collection date of the target battery, the model number of the target battery, the third reward, the operation rate calculated for each of the one or more display bases, the icon indicating the display base closest to the current location of each target user, and the icon indicating the display base group of which the reward is given to the target user by replacement of the target battery among the one or more display bases are displayed as the recommendation information using the map image.

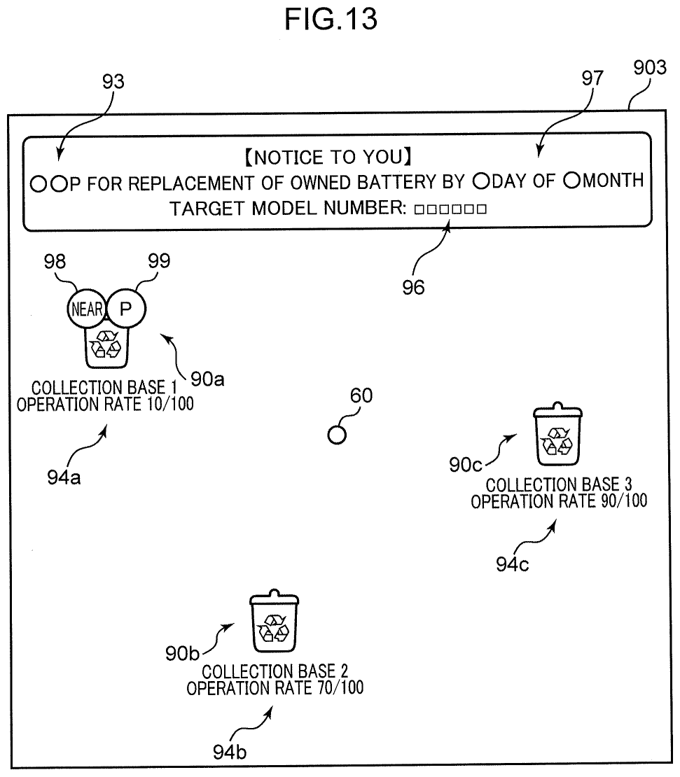

FIG. 13 is a diagram illustrating an example of a map image 903 including a third reward 93. For example, the generation unit 205 generates the map image 903 illustrated in FIG. 13. The map image 903 illustrates an example in which a current location 60 of the target user, positions 90a, 90b, and 90c of three display bases existing within a predetermined distance from the current location 60 of the target user, a collection date 97 of the target battery, a model number 96 of the target battery, a third reward 93, operation rates 94a, 94b, and 94c calculated for each of the three display bases, an icon 98 indicating a display base closest to the current location 60 of each target user, and an icon 99 indicating a display base group to which a reward is given to the target user by replacement of the target battery are displayed in a superimposed manner on a map image within a range within a predetermined distance from the current location 60 of the target user.

In this case, by referring to the map image 903, the target user can determine by which time, at which collection base 30 with a degree of the operation rate, and which battery 11 should be replaced to obtain the third reward 93 with the least movement.

Note that, instead of setting the third reward to a predetermined value, the generation unit 205 may set the third reward to the same value as the first reward described in the first embodiment, or to the same value as the second reward described in the second embodiment. Alternatively, the generation unit 205 may set the third reward to a sum or a product of the first reward and a predetermined value, or may set the third reward to a sum or a product of the second reward and a predetermined value. Alternatively, the generation unit 205 may set the third reward as a sum or a product of a sum or a product of the first reward and the second reward and a predetermined value.

In addition, the generation unit 205 may simplify the map image 903. For example, the generation unit 205 may not display one or more of the collection date 97 of the target battery, the model number 96 of the target battery, and the icon 98 indicating the display base closest to the current location 60 of each target user. In this case, by referring to the map image, the target user can determine at least at which degree of operation rate the battery 11 should be replaced in the collection base 30 to obtain the third reward 93.

In addition, instead of the icon 99 indicating the display base group to which the reward is given to the target user by the replace of the third reward and the target battery, the generation unit 205 may display, on the map image 903, information indicating whether each display base is a base to which the second reward is given to each target user by the replace of the target battery, such as a message “The collection base to which the third reward “○○P” is given is “collection base 1”.

In addition, the predetermined condition used when the generation unit 205 sets the third reward is not limited to the above-described predetermined condition “the operation rate is lowest among the one or more collection bases 30 existing in the information processing system 1000”. For example, the predetermined condition may be “the operation rate is lowest among the one or more transit bases through which the target batteries of the total collection number included in the provisional collection plan are collected”.

For example, in the example of FIG. 12, in step S7, the determination unit 204 prepares a provisional collection plan to sequentially visit two transit bases “collection base 2” and “collection base 3”. Therefore, the generation unit 205 may set, as the third reward, a reward given to each target user when the target battery is replaced in the collection base 30 “collection base 2” in which the lowest operation rate is calculated among the two transit bases “collection base 2” and “collection base 3”.

Alternatively, the predetermined condition may be “the operation rate is lowest among the collection base groups within a predetermined distance from a route to visit one or more transit bases through which the target batteries of the total collection number included in the provisional collection plan are collected among one or more collection bases 30 existing in the information processing system 1000”.

For example, in the example of FIG. 12, it is assumed that the collection base 30 “collection base 1” exists within a predetermined distance from a route sequentially visiting two transit bases “collection base 2” and “collection base 3”. In addition, in the example of FIG. 12, in step S7, the determination unit 204 prepares a provisional collection plan to sequentially visit two transit bases “collection base 2” and “collection base 3”. Therefore, the generation unit 205 may set, as the third reward, a reward given to each target user when the target battery is replaced in the collection base group “collection base 1” within a predetermined distance from a route sequentially visiting the two transit bases “collection base 2” and “collection base 3”.

The predetermined condition may be that “the operation rate is a predetermined value or less”. In this case, the generation unit 205 may set the third reward given to each target user when the target battery is replaced at each collection base in which the operation rate satisfying the predetermined condition “the operation rate is equal to or less than the predetermined value” is calculated such that the lower the operation rate calculated for each collection base 30, the higher the third reward.

### Fourth Embodiment

In the first to third embodiments, an example has been described in which the recommendation information is transmitted to the user terminal 6 when the second acquisition unit 202 acquires one collection target information. In the fourth embodiment, a method for displaying a plurality of map images when the user terminal 6 receives the plurality of map images displaying each of a plurality of different collection dates after the current date will be described.

Hereinafter, for convenience of description, a method in which, when the user terminal 6 receives two map images having collection dates of today and tomorrow, respectively, the two map images are displayed will be described as an example.

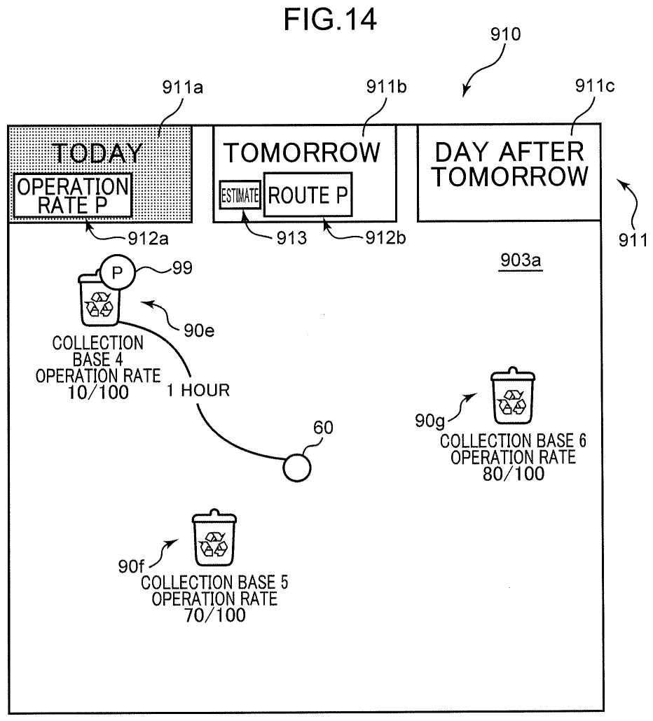

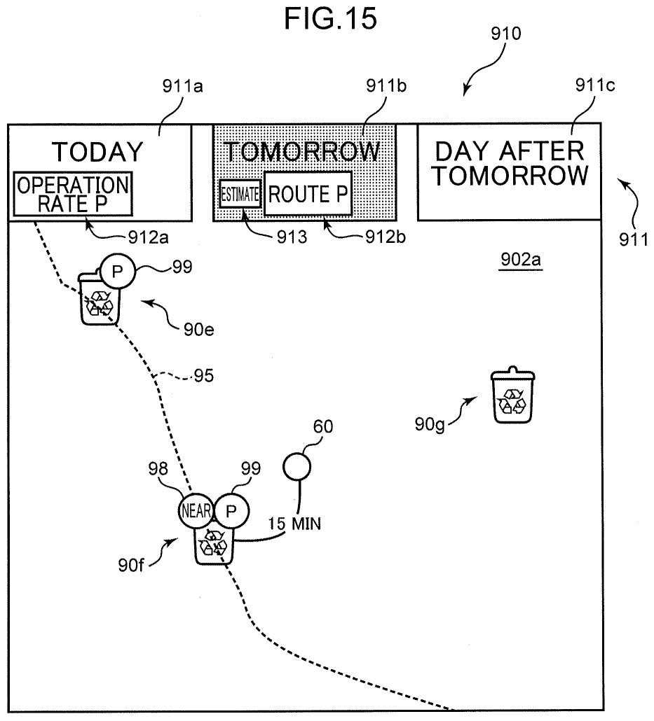

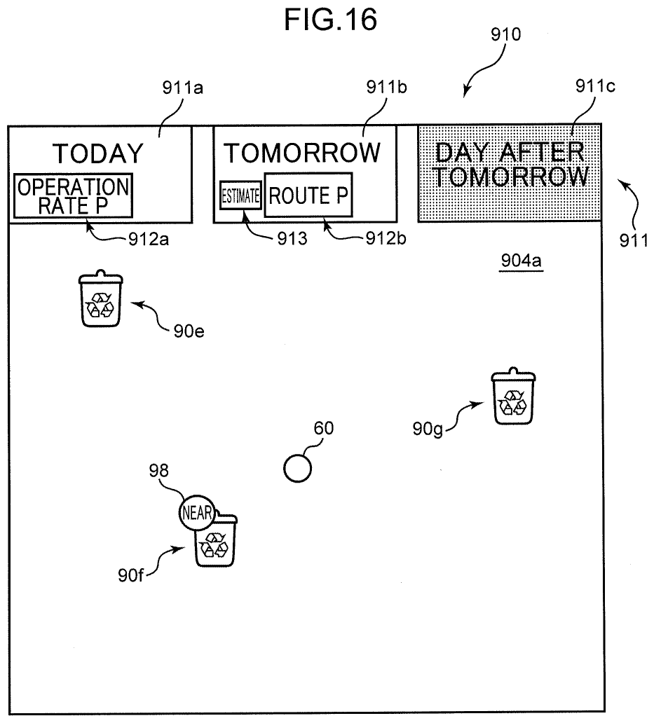

FIG. 14 is a diagram illustrating a display example of a map image 903a having today as a collection date on the user terminal 6. FIG. 15 is a diagram illustrating a display example of a map image 902a having tomorrow as a collection date on the user terminal 6. FIG. 16 is a diagram illustrating a display example of a predetermined map image 904a on the user terminal 6.

When receiving the map image 903a (first map image) displaying today (current date) as the collection date (first collection date) and the map image 902a (second map image) displaying tomorrow after today as the collection date (second collection date), the user terminal 6 displays a display screen 910 on the display.

The display screen 910 includes a tab region 911 for switching and displaying each of the three map images 903a, 902a, and 904a. The tab region 911 includes a tab 911a for performing an operation of displaying the map image 903a, a tab 911b for performing an operation of displaying the map image 902a, and a tab 911c for performing an operation of displaying the map image 904a.

FIG. 14 illustrates an example in which the display screen 910 displays the map image 903a when the selection operation is performed on the tab 911a. The map image 903a is a map image similar to the map image 903 (FIG. 13) described in the third embodiment, and includes a current location 60 of the target user, positions 90e, 90f, and 90g of three display bases existing within a predetermined distance from the current location 60 of the target user, operation rates 94e, 94f, and 94g calculated for each of the three display bases, an icon 98 indicating a display base closest to the current location 60 of each target user, and an icon 99 indicating a display base group to which a reward is given to the target user by replacement of the target battery, in a map image within a range within a predetermined distance from the current location 60 of the target user.

When the selection operation is performed on the icon 99, the user terminal 6 hides the tab region 911 and displays the collection date 97 (FIG. 13) of the target battery, the model number 96 (FIG. 13) of the target battery, and the third reward 93 (FIG. 13) included in the map image 903a, similarly to the map image 903 (FIG. 13) described in the third embodiment. The user terminal 6 displays, on the tab 911a, the collection date “today” and an icon 912a indicating the third reward 93 that is the content of the reward included in the map image 903a.

FIG. 15 illustrates an example in which the display screen 910 displays the map image 902a when the selection operation is performed on the tab 911b. The map image 902a is a map image similar to the map image 902 (FIG. 11) described in the second embodiment, and includes, in a map image in a range within a predetermined distance from the current location 60 of the target user, the current location 60 of the target user, positions 90e, 90f, and 90g of three display bases existing within the predetermined distance from the current location 60 of the target user, a route 95 to visit each display base included in the one or more transit bases among the three display bases, an icon 98 indicating a display base closest to the current location 60 of each target user, and an icon 99 indicating a display base group to which a reward is given to the target user by replacement of the target battery.

When the selection operation is performed on the icon 99, the user terminal 6 hides the tab region 911 and displays the collection date 97 (FIG. 11) of the target battery, the model number 96 (FIG. 11) of the target battery, and the second reward 92 (FIG. 11) included in the map image 902a, similarly to the map image 902 (FIG. 12) described in the second embodiment. The user terminal 6 displays, on the tab 911b, the collection date “tomorrow” and an icon 912b indicating the second reward 92 that is the content of the reward included in the map image 902a.

FIG. 16 illustrates an example in which the display screen 910 displays the map image 904a when the selection operation is performed on the tab 911c. The map image 904a includes, in a map image in a range within a predetermined distance from the current location 60 of the target user, the current location 60 of the target user, positions 90e, 90f, and 90g of three display bases which are three collection bases 30 existing within a predetermined distance from the current location 60 of the target user among one or more collection bases 30 existing in the information processing system 1000, and an icon 98 indicating a display base closest to the current location 60 of each target user.

The map image 904a is generated by the generation unit 205 at a predetermined timing such as when the use of the information processing system 1000 is registered in step S1 (FIG. 5), for example, and is returned by the output unit 206. The generation unit 205 refers to the map information storage unit 221 and the master information storage unit 222 to generate the map image 904a. The user terminal 6 displays the collection date “day after tomorrow” on the tab 911c.

According to the fourth embodiment, the target user can switch and display the map image 903a and the map image 902a while confirming the contents of the reward by operating the display screen 910. As a result, the target user can determine what kind of reward can be obtained by replacing the target battery in which display base.

A modification below can be employed for the present disclosure.
(1) In the first to fourth embodiments described above, the generation unit 205 may further include, in the map image generated as the recommendation information, the movement time from the current location of each target user to the display base closest to the current location of each target user in the display base group in which reward is given to each target user by replacement of the target battery. This configuration can be achieved as described below, for example.

A learned model that has learned a relationship between a geographical feature quantity between two points in a predetermined area targeted by the information processing system 1000 and a movement time by the user 600 of the information processing system 1000 between the two spots is stored in advance in the memory 22. The geographical feature quantity between two spots is, for example, a distance and an altitude difference of the shortest route between the two spots.

The generation unit 205 calculates, based on the map information stored in the map information storage unit 221, a geographical feature quantity between the current location of each target user and a display base closest to the current location of each target user in a display base group in which each target user is rewarded by replacing the target battery, and a movement route from the current location of each target user to the closest display base. The generation unit 205 acquires the movement time output by the learned model by inputting the calculated geographical feature quantity to the learned model. Note that the generation unit 205 may calculate the movement time based on the map information stored in the map information storage unit 221 by a method different from this method. The generation unit 205 displays the acquired movement time and the calculated movement route on the map image included in the recommendation information.

For example, the map image 902a illustrated in FIG. 15 illustrates an example in which a movement route and a movement time “15 minutes” from the current location 60 of the target user to the display base closest to the current location 60 of each target user among the display base group in which a reward is given to the target user by replacement of the target battery are displayed. According to the present configuration, the target user can determine in which display base the target battery is replaced to obtain the reward in the least movement time.

Similarly, the generation unit 205 may further include the movement route and the movement time from the current location 60 of each target user to the display base closest to the current location 60 of each target user in the map image 904a (FIG. 16) in the range within the predetermined distance from the current location of the target user described in the fourth embodiment.
(2) In the modification of the above (1), the user terminal 6 may display an icon indicating that it is a map image indicating a method of replacing the battery 11 most recommended to the target user on any tab included in the tab region 911 (FIGS. 14, 15, and 16).

For example, FIGS. 14, 15, and 16 illustrate an example in which the user terminal 6 determines the map image 902a including the least movement time “15 minutes” as the map image illustrating the method of replacing the battery 11 most recommended to the target user, and displays the icon 913 on the tab 911b for performing the operation of displaying the map image 902a. Note that the user terminal 6 may determine a map image indicating a method of replacing the battery 11 most recommended to the target user by another method.
(3) In the first to fourth embodiments and the modifications, the collection target information may further include a required time required for collecting the target battery.

In this case, the determination unit 204 may refer to the collection state information storage unit 223 and the collection plan information storage unit 225 to determine whether the total collection number of target batteries collectable from the one or more collection bases 30 within the required time included in the collection target information is equal to or larger than the collection number of target batteries included in the collection target information.

When preparing a collection plan, the determination unit 204 may determine, by a predetermined algorithm, one or more collection bases 30 to visit within the required time to collect the target batteries of the collection number, a route to visit the one or more collection bases 30, and the number of target batteries to be collected by each of the one or more collection bases 30. Similarly, when preparing the provisional collection plan, the determination unit 204 may determine, by a predetermined algorithm, one or more collection bases 30 to visit within the required time to collect the target batteries of the total collection number, a route to visit the one or more collection bases 30, and the number of target batteries to be collected by each of the one or more collection bases 30.

According to this configuration, it is possible to determine whether the target battery is collectable from the collection base 30 in consideration of not only the battery 11 collected by the collection base 30 but also the required time required for collecting the target battery.
(4) In the first to fourth embodiments and the modifications, information indicating reward may not be included in the recommendation information. Specifically, the generation unit 205 may include, in the recommendation information, a message recommending replacement of the target battery in the collection base 30, for example, “please, replace the battery of model number XX you own in the collection base”. Note that XX is the model number of the target battery. In accordance with this, the generation unit 205 may not display the reward on the map image included in the recommendation information.

Note that the present disclosure is not limited to a use case where the mobility agent 301 (FIGS. 1 and 2) collects the battery 11 for a mobile device such as a mobility or a notebook computer, and is also applicable to a use case where an energy management operation agent or an aggregator collects a battery used in energy management. The battery used in the energy management includes, for example, a stationary storage battery, a fuel cell, a solar cell, and the like.

According to the present disclosure, it is possible to efficiently collect a battery to be collected in consideration of not only a battery owned by a user but also information on a battery collected by a base, which is useful for conducting a business of reusing or recycling a battery.

1. An information processing method for causing a computer to execute:
acquiring first information on a battery collected by a base;
acquiring second information on a target battery to be collected;
determining whether the target battery is collectable from the base based on the first information and the second information;
when it is determined that the target battery is not collectable from the base, acquiring third information on a battery owned by each of one or more users;
specifying one or more target users who own the target battery based on the third information; and
outputting fourth information recommending replacement of the target battery at the base to a terminal device used by each of the one or more target users.

2. The information processing method according to claim 1, wherein the fourth information includes information indicating a reward given to each target user when the target battery is replaced at the base.

3. The information processing method according to claim 2, wherein the reward includes a higher first reward as a matching degree between the second information and information on the target battery owned by each target user included in the third information is higher.

4. The information processing method according to claim 3, wherein
the second information includes a range of an SOH of the target battery,
the third information includes an SOH of a battery owned by each user, and
the matching degree is higher as a target SOH, which is an SOH of the target battery owned by each target user, included in the third information falls within the range and is closer to an upper limit value of the range.

5. The information processing method according to claim 2, wherein
the base includes one or more collection bases, and
the method comprises:
acquiring current locations of the one or more users and positions of the one or more collection bases; and
outputting, as the fourth information, a map image on which a current location of each target user, positions of one or more display bases existing within a predetermined distance from the current location of each target user among the one or more collection bases, and information indicating whether each display base is a base where the reward is given to each target user by replacement of the target battery.

6. The information processing method according to claim 2, wherein the reward includes a second reward given to each target user when the target battery is replaced at the base through which the target battery is collected.

7. The information processing method according to claim 6, wherein
the base includes one or more collection bases,
the first information includes a number of batteries collected by each collection base,
the second information includes a collection number that is the number of target batteries to be collected, and
the method further comprises, when a total collection number, which is a total number of the target batteries collectable from the one or more collection bases, is less than the collection number, specifying one or more transit bases through which the target batteries of the total collection number are collected.

8. The information processing method according to claim 7, further comprising:
acquiring current locations of the one or more users and positions of the one or more collection bases; and
outputting, as the fourth information, a map image on which a current location of each target user, positions of one or more display bases existing within a predetermined distance from the current location of each target user among the one or more collection bases, a collection route to visit the one or more transit bases, and information indicating whether each display base is a base to which the second reward is given to each target user by replacement of the target battery are displayed.

9. The information processing method according to claim 2, wherein
the base includes one or more collection bases,
the first information includes a number of batteries collected by each collection base and the total number of batteries that are collectable by each collection base,
the method further comprises calculating, for each of the one or more collection bases,
an operation rate that is a ratio of a number of batteries collected by each collection base to a total number of batteries collectable by each collection base based on the first information, and
the reward includes a third reward given to each target user when the target battery is replaced in a collection base group in which the operation rate satisfying a predetermined condition is calculated among the one or more collection bases.

10. The information processing method according to claim 9, wherein the predetermined condition is that the operation rate is lowest among the one or more collection bases.

11. The information processing method according to claim 9, wherein
in the determining,
when it is determined that the target battery is not collectable from the base, one or more transit bases are further specified through which the target batteries of a total collection number are collected, the total collection number being a total number of the target batteries collectable from the one or more collection bases, and
the predetermined condition is that the operation rate is lowest among the one or more transit bases.

12. The information processing method according to claim 9, further comprising:
when it is determined that the target battery is not collectable from the base,
determining a route to visit one or more transit bases by specifying the one or more transit bases through which the target batteries of a total collection number are collected, the total collection number being a total number of the target batteries collectable from the one or more collection bases,
wherein the predetermined condition is that the operation rate is lowest among a collection base group within a predetermined distance from the route among the one or more collection bases.

13. The information processing method according to claim 9, further comprising:
acquiring current locations of the one or more users and positions of the one or more collection bases; and
outputting, as the fourth information, a map image on which a current location of each target user, positions of one or more display bases existing within a predetermined distance from the current location of each target user among the one or more collection bases, the operation rate calculated for each of the one or more display bases, and information indicating whether each display base is a base to which the third reward is given to each target user by replacement of the target battery are displayed.

14. The information processing method according to claim 5, wherein the map image further displays a movement time from a current location of each target user to a display base closest to the current location of each target user among the one or more display bases.

15. The information processing method according to claim 1, wherein
the base includes one or more collection bases,
the first information includes a number of batteries collected by each collection base and a total number of batteries that are collectable by each collection base,
the second information includes a collection number that is a number of the target batteries to be collected,
in the determining,
the target battery is determined to be collectable from the base when a total collection number, which is a total number of the target batteries collectable from the one or more collection bases, is equal to or larger than a number of the target batteries,
when it is determined that the target battery is collectable from the base,
one or more transit bases through which the target batteries of the collection number are collected are specified, and further a route to visit the one or more transit bases is determined, and
information including the one or more transit bases and the route is output to a terminal device used by a provider of the second information.

16. The information processing method according to claim 1, wherein the second information further includes a required time required for collecting the target battery.

17. A display method in the terminal device according to claim 5, comprising:
when a first map image on which a first collection date after a current date is displayed and a second map image on which a second collection date after the first collection date is displayed are received, displaying a screen on which an operation of displaying the first map image and the second map image is possible in a switched manner,
wherein the screen includes an icon indicating contents of the reward included in the first map image and the second map image.

18. An information processing device comprising:
a first acquisition unit that acquires first information on a battery collected by a base;
a second acquisition unit that acquires second information on a target battery to be collected;
a determination unit that determines whether the target battery is collectable from the base based on the first information and the second information;
a third acquisition unit that, when the determination unit determines that the target battery is not collectable from the base, acquires third information on a battery owned by each of one or more users;
a specification unit that specifies one or more target users who own the target battery based on the third information; and
an output unit that outputs fourth information recommending replacement of the target battery at the base to a terminal device used by each of the one or more target users.

19. A non-transitory computer readable storage medium storing a control program for causing a computer to function as:
a first acquisition unit that acquires first information on a battery collected by a base;
a second acquisition unit that acquires second information on a target battery to be collected;
a determination unit that determines whether the target battery is collectable from the base based on the first information and the second information;
a third acquisition unit that, when the determination unit determines that the target battery is not collectable from the base, acquires third information on a battery owned by each of one or more users;
a specification unit that specifies one or more target users who own the target battery based on the third information; and
an output unit that outputs fourth information recommending replacement of the target battery at the base to a terminal device used by each of the one or more target users.
